(19) United States
(12) Patent Application Publication
(10) Pub. No.: US 2026/0217954 A1
(43) Pub. Date: Jul. 30, 2026

(54) PNEUMATIC TIRE

(71) Applicant: Sumitomo Rubber Industries, Ltd., Kobe-shi (JP)

(72) Inventors: Tetsuya KONDO, Kobe-shi (JP); Kazuchika SUGAHARA, Kobe-shi (JP)

(73) Assignee: Sumitomo Rubber Industries, Ltd., Kobe-shi (JP)

(21) Appl. No.: 19/457,908

(22) Filed: Jan. 23, 2026

(30) Foreign Application Priority Data
Jan. 28, 2025 (JP) 2025-012084

(51) Int. Cl. C08L 15/00; B60C 1/00; B60C 11/00; B60C 11/03; C08K 3/36

(52) U.S. Cl. CPC C08L 15/00; B60C 1/0016; B60C 11/0008; C08K 3/36; B60C 2011/0025; B60C 2011/0355; C08K 2201/006; C08L 2205/025; C08L 2205/035; C08L 2207/322; C08L 2207/324

(57) ABSTRACT

The present invention aims to further improve wet grip performance of a pneumatic tire. The pneumatic tire has a tread portion in which a main groove is formed in the tire circumferential direction. The tread portion is formed of a rubber composition. The rubber composition contains, as a rubber component, styrene butadiene rubber having a Tg of −60° C. or less, and less than 40 parts by mass of an isoprene-based rubber per 100 parts by mass of a total rubber component, and contains, as a filler, 100 parts by mass or more of silica having a CTAB specific surface area of 190 m²/g or more, per 100 parts by mass of the total rubber component. The depth D (mm) of the main groove and a total content FA (parts by mass) of the filler per 100 parts by mass of the total rubber component satisfy “D×FA>800”.

### TECHNICAL FIELD

The present invention relates to a pneumatic tire.

### BACKGROUND ART

From the viewpoint of safety, pneumatic tires are required to have good wet grip performance, and various techniques have been proposed (for example, Patent Documents 1 to 4), but they are still not sufficient.

### PRIOR ART DOCUMENTS

### Patent Documents

[Patent Document 1] JP 2016-043709 A
[Patent Document 2] JP 2018-135436 A
[Patent Document 3] WO 2018/143380
[Patent Document 4] JP 2019-119757 A

### SUMMARY OF THE INVENTION

### Problem to be Solved by the Invention

Therefore, the object of the present invention is to further improve wet grip performance of pneumatic tires.

### Means for Solving the Problem

The present invention provides a pneumatic tire having a tread portion in which a main groove is formed in the tire circumferential direction, wherein
the tread portion is formed of a rubber composition which contains,
as a rubber component, styrene butadiene rubber (SBR) having a glass transition temperature of −60° C. or less, and less than 40 parts by mass of an isoprene-based rubber per 100 parts by mass of a total rubber component, and
at least as a filler, 100 parts by mass or more of silica having a CTAB (Cetyl Tri-methyl Ammonium Bromide) specific surface area of 190 m²/g or more, per 100 parts by mass of the total rubber component, and
the depth D (mm) of the main groove and a total content FA (parts by mass) of the filler per 100 parts by mass of the total rubber component satisfy the following formula (1):

$$D \times FA > 800. \qquad ( 1 )$$

### Effects of the Invention

According to the present invention, it is possible to further improve wet grip performance of a pneumatic tire.

### BRIEF EXPLANATION OF DRAWINGS

FIG. 1 shows a schematic cross-sectional view illustrating a tire according to one embodiment of the present invention.

FIG. 2 shows an enlarged cross-sectional view of a near portion of a tread portion of the tire in FIG. 1.

### EMBODIMENTS FOR CARRYING OUT THE INVENTION

### [1] Features of a Pneumatic Tire According to the Present Invention

First, the features of the pneumatic tire (hereinafter also simply referred to as “tire”) according to the present invention are described.

### 1. Overview

The tire according to the present invention is a pneumatic tire having a tread portion in which a main groove is formed in the tire circumferential direction, wherein the tread portion is formed of a rubber composition which contains, as a rubber component, styrene butadiene rubber (SBR) having a glass transition temperature of −60° C. or less, and less than 40 parts by mass of an isoprene-based rubber per 100 parts by mass of a total rubber component, and contains, at least as a filler, 100 parts by mass or more of silica having a CTAB (Cetyl Tri-methyl Ammonium Bromide) specific surface area of 190 m²/g or more, per 100 parts by mass of the total rubber component.

Furthermore, the depth D (mm) of the main groove and a total content FA (parts by mass) of the filler per 100 parts by mass of the total rubber component satisfy the following formula (1). In this specification, the depth D of the main groove is measured along normal to the surface extending from the surface forming the ground contact surface on the outermost surface of the tread. And the depth D means the distance from the surface extending from the surface forming the ground contact surface to the deepest point of the bottom of the main groove. Further, the depth D refers to the maximum distance among the depths of the main grooves provided.

$$D \times FA > 800 \qquad ( 1 )$$

With these features, the pneumatic tire can be improved further in wet grip performance, as described below.

In the present invention, the tread portion is a component for a region forming a ground contact surface of the tire, and refers to a portion radially outward of components containing a fiber material, such as a carcass, a belt layer, and a belt reinforcing layer, in the tire.

### 2. Mechanism of Effect Manifestation in a Tire According to the Present Invention

The tire of the present invention is believed to achieve the above-described effects through the following mechanism.

### (1) Containing of an SBR Having a Low Tg

As described above, for the rubber composition forming a tread portion of the tire (rubber composition for tread) according to the present invention, styrene butadiene rubber (SBR) having a glass transition temperature of −60° C. or less is used as a rubber component. When the tread portion is formed with a multi-layer structure of a cap rubber layer and a base rubber layer, the “rubber composition for tread” refers to a rubber composition forming the cap rubber layer.

By the rubber component containing SBR having a glass transition temperature (Tg) of −60° C. or less (low Tg SBR), softness of the rubber composition is maintained even during running, improving the performance to conform to road surfaces, which is thought to improve the wet grip performance of the tire.

In the present invention, “SBR has a glass transition temperature of −60° C. or less” means that the glass transition temperature of SBR contained in a rubber composition for tread is −60° C. or less.

The glass transition temperature of SBR can be determined from a distribution curve of tan δ against temperature measured using a viscoelasticity measuring device such as “EPLEXOR” (registered trademark) series manufactured by GABO Corporation. Specifically, the distribution curve of tan δ against temperature is measured under conditions of a frequency of 10 Hz, an initial strain of 10%, an amplitude of ±0.5%, and a heating rate of 2° C./min, and a temperature corresponding to the largest tan δ value in the range of −100° C. to 40° C. on the distribution curve against temperature is defined as the glass transition temperature. If there are two or more points with the largest tan δ value in the range of −100° C. to 40° C., the temperature corresponding to a point at the lowest temperature among them is defined as the glass transition temperature. For example, in the present invention, if the maximum value of tan δ is in the range of −100° C. to 40° C., the temperature showing the maximum value is defined as the glass transition temperature according to the above definition. For example, when a distribution curve against temperature is obtained in which tan δ gradually decreases as the temperature increases within a range of −100° C. or more and 40° C. or less, and the temperature showing the maximum value of tan δ is-100° C., the glass transition temperature is −100° C. according to the above definition.

### (2) Isoprene Rubber Content

In the present invention, as a rubber component, in addition to the above-mentioned SBR having a low Tg, less than 40 parts by mass of an isoprene-based rubber per 100 parts by mass of the total rubber component are contained.

This allows a phase-separated structure to be formed between SBR and the isoprene-based rubber, allowing microscopic layers of different hardness to be mixed within the rubber phase. The presence of numerous interfaces between the microscopic layers makes it possible to suppress propagation of impacts and cracks from the surface of the tire, which is thought to improve wet grip performance of the tire.

### (3) Silica Content

In the present invention, the rubber composition forming a tread portion of the tire contains, as a filler, at least silica, which has a CTAB specific surface area of 190 m²/g or more, in a large amount, such as 100 parts by mass or more per 100 parts by mass of the rubber component.

Furthermore, by appropriately containing a large amount of silica having a CTAB specific surface area of 190 m²/g or more, the tread portion that flexes when it contacts with a road surface during rolling can easily return to its original shape when it leaves the road surface, and can easily flex again when it contacts with a road surface again, which is thought to improve wet grip performance of the tire. Alternatively, the silica in the surface region of the tread portion interacts with a wet road surface, and the followability to the road surface is improved, and, as a result, it is thought to improve the wet grip performance of the tire.

In the present invention, the CTAB specific surface area is a value measured in accordance with ASTM D3765-92. When two or more types of silica are used, the CTAB specific surface area is the average value obtained by dividing the sum of the products of the content (parts by mass) of each silica and its CTAB (m²/g) by the total amount of silica (parts by mass).

### (4) Relationship Between Main Groove Depth and Filler Content

It is believed that increasing the depth of a main groove and the filler content improves the contact of the tread with a road surface, improving followability of the tire to the road surface and improving wet grip performance of the tire.

Specifically, when the product (D×FA) of the depth D (mm) of the main groove and the total content FA (parts by mass) of the filler per 100 parts by mass of the rubber component exceeds 800, it is believed that the tire has good road surface followability and improved wet grip performance.

In the present invention, it is believed that the effects (1) to (4) above work together to further improve wet grip performance of the tire.

### [2] More Preferred Embodiments of Tires of the Present Invention

The tire of the present invention can achieve even greater effects by adopting the following aspects.

### 1. SBR

### (1) Glass Transition Temperature (Tg)

As described above, in the present invention, the glass transition temperature (Tg) of SBR contained in the rubber composition forming a tread portion is −60° C. or less, preferably −65° C. or less, more preferably −70° C. or less, even more preferably −73° C. or less, and even more preferably −80° C. or less. On the other hand, the lower limit is, for example, preferably −100° C. or more, and more preferably −90° C. or more.

### (2) Styrene Content

In the present invention, the styrene content of the SBR is preferably 25 mass % or less, more preferably 20 mass % or less, even more preferably 18 mass % or less, and even more preferably 10 mass % or less, while the lower limit is, for example, preferably 1 mass % or more, more preferably 3 mass % or more, and even more preferably 5 mass % or more.

By incorporating SBR having a low styrene content and a low glass transition temperature, specifically, a styrene content of 25% by mass or less and a glass transition temperature of −60° C. or less (low styrene content/low Tg SBR) into the rubber component, an appropriate amount of styrene moiety is generated in the rubber component, facilitating the formation of minute styrene domains. The formation of such minute styrene domains increases mobility of polymers at the interface with molecular chains of other rubber components, allowing for flexible movement, which is thought to absorb and mitigate external (road surface) impacts that the tire receives while running, further improving followability to road surfaces and further improving wet grip performance of the tire.

The styrene content and the vinyl content of SBR described below as well as the styrene content and the vinyl content in the rubber component can be measured, for example, using NMR measurement (¹H-NMR or ¹³C-NMR). Unlike values of physical property, such as complex modulus (E*), the content of a component, such as, “styrene content” or “vinyl content” has a true value that is independent from the measurement method, so it is preferable to use a measurement method with as high accuracy as possible. In Examples in this specification, the total styrene content in the rubber component and the like are calculated according to the calculation formulas described in this specification, but, for example, they may also be analyzed the tire using Py-GC/MS or the like.

In addition, in the case of a rubber composition after vulcanization, the styrene content can also be calculated by determining content of the styrene contained in the rubber component after acetone extraction using solid-state nuclear magnetic resonance (solid-state NMR) or Fourier transform infrared spectroscopy (FTIR).

### (3) Vinyl Content

In the present invention, the vinyl content of the SBR is preferably 15 mass % or less, more preferably 10 mass % or less, and even more preferably 9 mass % or less, while the lower limit is, for example, preferably 7 mass % or more, and more preferably 8 mass % or more.

By incorporating an SBR having a low vinyl content and a low glass transition temperature, specifically a SBR having a vinyl content of 15 mass % or less and a glass transition temperature of −60° C. or less, into the rubber component, softness of the rubber composition is maintained even during high-speed running, improving its followability to to road surfaces, and it is believed that the wet grip performance of the tire is further improved.

Here, the vinyl content of SBR may indicate the proportion of vinyl bonds relative to 100 mass % of a butadiene portion of the SBR, and can be calculated by (100 [mass %]-Styrene content of the SBR [mass %])×Vinyl content of the SBR [% by mass]/100.

### 2. Styrene Content and Vinyl Content in the Rubber Component

Regarding the styrene content and the vinyl content in the SBR is described above, while, in the present invention, the styrene content in the rubber component is preferably 25 mass % or less, more preferably 20 mass % or less, even more preferably 16.25 mass % or less, even more preferably 14.40 mass % or less, even more preferably 11.70 mass % or less, even more preferably 10.98 mass % or less, even more preferably 10.80 mass % or less, even more preferably 10 mass % or less, and even more preferably 9.90 mass % or less. On the other hand, the lower limit is, for example, preferably 1 mass % or more, more preferably 3 mass % or more, and even more preferably 5 mass % or more.

The vinyl content in the rubber component is preferably 15 mass % or less, and more preferably 9 mass % or less, while the lower limit is, for example, more preferably 5.13 mass % or more, even more preferably 5.61 mass % or more, even more preferably 6.10 mass % or more, even more preferably 6.32 mass % or more, even more preferably 6.45 mass % or more, even more preferably 6.66 mass % or more, even more preferably 6.91 mass % or more, even more preferably 7 mass % or more, even more preferably 8 mass % or more, and even more preferably 8.20 mass % or more.

It is believed that the wet grip performance of the tire can be further improved by appropriately controlling the styrene content and the vinyl content in the rubber component.

Here, the “styrene content in the rubber component” refers to the amount of styrene contained in the entire styrene-containing polymer, such as SBR, contained as a rubber component in the rubber composition for tread. In addition to SBR, examples of the styrene-containing polymer include a styrene-isoprene copolymer and a styrene-ethylene copolymer.

For example, when one type of SBR is contained in the rubber component as the styrene-containing polymer, the styrene content of the SBR is “styrene content in the rubber component”, and when multiple types of styrene-containing polymers are contained in the rubber component, the “styrene content in the rubber component” is the value obtained by dividing the sum of the products of the styrene content (mass %) in each polymer and the blending amount (parts by mass) of the polymer per 100 parts by mass of the total rubber component by the sum of the blending amounts (parts by mass) of each polymer per 100 parts by mass of the total rubber component.

More specifically, when 100 parts by mass of the rubber component contain, as the styrene-containing polymer, SBR1 (X1 parts by mass) having a styrene content of S1 mass % and SBR2 (X2 parts by mass) having a styrene content of S2 mass %, the styrene content can be calculated from the formula {(S1×X1)+(S2×X2)}/(X1+X2).

Here, “the vinyl content in the rubber component” means the proportion (mass %) of butadiene forming vinyl bonds in the butadiene part of the butadiene-containing polymer when the total mass of butadiene-containing polymers such as SBR and butadiene rubber (BR) contained as rubber components in the rubber composition for tread. In addition to the above-mentioned SBR and BR, examples of the butadiene-containing polymers include copolymers of butadiene and another compound.

The vinyl content in the rubber component can be calculated by the following method.

(a) when the Butadiene Containing Polymer is Only One Type of SBR

More specifically, when 100 parts by mass of the rubber component contain, as the styrene-containing polymer, SBR1 (X1 parts by mass) having a styrene content of S1 mass % and SBR2 (X2 parts by mass) having a styrene content of S2 mass %, the styrene content can be calculated from the formula {(S1×X1)+(S2×X2)}/(X1+X2).

(b) when the Butadiene-Containing Polymer is a Mixture of Multiple Types of SBR (No Other Butadiene-Containing Polymers Such as BR is not Included)

When the butadiene-containing polymer contained in the rubber component is a plurality of types of SBR and no other butadiene-containing polymer is contained, the “vinyl content in the rubber component” can be calculated by Σ{content of each SBR×(100 [mass %]−styrene content of each SBR [mass %])×vinyl content of each SBR [mass %]}/2 (content of each SBR). As a specific example, if 100 parts by mass of the rubber component contains 75 parts by mass of SBR having a styrene content of 40 mass % and a vinyl content of 30 mass %, 15 parts by mass of SBR having a styrene content of 25 mass % and a vinyl content of 20 mass %, and the remaining 10 parts by mass is a component other than SBR, the effective vinyl content of the SBR is 17.5 mass % (={75×(100 [mass %]−40 [mass %])×30 [mass %]+15×(100 [mass %]−25 [mass %])×20 [mass %]}/(75+15)/100).

(c) when the Butadiene-Containing Polymer is a Mixture of Multiple Types of SBR and Other Butadiene-Containing Polymers

When the butadiene-containing polymer contained in the rubber component is a plurality of types of SBR and further contains other butadiene-containing polymers, the “vinyl content in the rubber component” can be calculated by Σ {content of each SBR×(100 [mass %]−styrene content of each SBR [mass %])×vinyl content of each SBR [mass %]}/100+{content of each butadiene-containing polymer×vinyl content of each butadiene-containing polymer [mass %]/100}/Σ (content of all butadiene-containing polymers). As a specific example, if 100 parts by mass of the rubber component are composed of 85 parts by mass of styrene-butadiene rubber having a styrene content of 40 mass % and a vinyl content of 30 mass %, 5 parts by mass of styrene-butadiene rubber having a styrene content of 20 mass % and a vinyl content of 20 mass %, and 10 parts by mass of butadiene rubber having a vinyl content of 10 mass %, the “vinyl content in the rubber component” is 16.1 mass % (=0.85×(100 [mass %]−40 [mass %])×30 [mass %]+0.05×(100 [mass %]−20 [mass %])×20 [mass %]+0.10×10 [mass %])/100.

### 3. Isoprene Based Rubber

In the present invention, as described above, less than 40 parts by mass of an isoprene-based rubber is contained in 100 parts by mass of the rubber component, and less than 35 parts by mass is preferably, less than 30 parts by mass is even more preferably, and 20 parts by mass or less is even more preferably contained. On the other hand, the lower limit is, for example, preferably 1 part by mass or more, more preferably 3 parts by mass or more, even more preferably 5 parts by mass or more.

### 4. Silica

As described above, in the present invention, the content of silica contained, as a filler, in the rubber composition forming a tread portion of the tire is 100 parts by mass, or more, preferably 130 parts by mass or more, more preferably 140 parts by mass or more, even more preferably 150 parts by mass or more, and even more preferably 160 parts by mass or more, per 100 parts by mass of the total rubber component. On the other hand, as an upper limit, taking into consideration kneading processability and molding processability of the rubber composition, it is, for example, preferably 250 parts by mass or less, more preferably 220 parts by mass or less, even more preferably 190 parts by mass or less, and even more preferably 180 parts by mass or less.

In the present invention, CTAB specific surface area of the silica is preferably 190 m²/g or more, more preferably 200 m²/g or more, and even more preferably 210 m²/g or more, even more preferably 233 m²/g. Meanwhile, the upper limit is, for example, preferably 270 m²/g or less, more preferably 260 m²/g or less, even more preferably 250 m²/g or less, even more preferably 245 m²/g or less.

### 5. Resin Component

In the present invention, the rubber composition forming a tread portion of the tire contains a resin component preferably 30 parts by mass or more, per 100 parts by mass of the total rubber component, more preferably 50 parts by mass or more, and even more preferably 60 parts by mass or more. On the other hand, the upper limit is, for example, preferably 100 parts by mass or less, more preferably 95 parts by mass or less, even more preferably 90 parts by mass or less, and even more preferably 80 parts by mass or less. It is believed that, by adhesiveness of the resin component, the tire is improved in contact performance with the road surface, and is further improved in wet grip performance.

As a specific resin component, an aromatic resin, a dicyclopentadiene resin (DCPD-C9 resin), and a terpene resin are preferred.

### 6. Acetone Extractable Content of the Rubber Composition for Tread

In the present invention, acetone extractable content of the rubber composition forming the tread is preferably 23 mass % or more, more preferably 24 mass % or more, even more preferably 24.43 mass % or more, even more preferably 24.50 mass % or more, even more preferably 24.94 mass % or more, even more preferably 25 mass % or more, even more preferably 25.27 mass % or more, even more preferably 25.74 mass % or more, even more preferably 25.84 mass % or more, and even more preferably 26.71 mass % or more. On the other hand, the upper limit is, for example, preferably 40 mass % or less, more preferably 30 mass % or less, even more preferably 29.70 mass % or less, even more preferably 29.57 mass % or less, even more preferably 29.55 mass % or less, even more preferably 29.43 mass % or less, even more preferably 29.42 mass % or less, even more preferably 29.13 mass % or less, even more preferably 29.08 mass % or less, even more preferably 29.07 mass % or less, even more preferably 29.01 mass % or less, even more preferably 28.93 mass % or less, even more preferably 28.92 mass % or less, even more preferably 28.90 mass % or less, even more preferably 28.56 mass % or less, even more preferably 28.17 mass % or less, even more preferably 28 mass % or less, and even more preferably 27.93 mass % or less.

The acetone extractable content (AE amount: Acetone Extract) may be considered as an index relating to the amount of softeners and the like in rubber compositions, and may also be considered as an index relating to softness of rubber compositions. Therefore, when the acetone extractable content is increased to a certain extent in a rubber composition forming a tread, the tread portion becomes soft, and deforms flexibly, ensuring a sufficient area for the tire to contact with the road surface, improving ground contact, and further improving wet grip performance of the tire.

The acetone extractable content can be measured in accordance with JIS K 6229:2015. Specifically, after a test piece of a vulcanized rubber cut out from the measurement site is immersed in acetone for a predetermined time, the loss rate (%) of the mass of the test piece is determined, thereby obtaining the acetone extractable content (mass %).

More specifically, each vulcanized rubber test piece is immersed in acetone at room temperature and normal pressure for 72 hours for extraction of soluble components, and the mass of each test piece is measured before and after the extraction, and the acetone extractable content AE (mass %) can be calculated using the following formula.

$$AE = \{ ( mass of the rubber test piece before the extraction - mass of the rubber test piece after the extraction ) / ( mass of rubber test piece before extraction ) \} \times 100$$

The acetone extractable content may be appropriately varied by, for example, changing the compounding ratio of a plasticizer in the rubber composition for tread.

7. Product of Main Groove Depth D (mm)×Total Filler Content FA (Parts by Mass) (D×FA)

As described above, in the present invention, the product (D×FA) of the main groove depth D (mm) and the total filler content FA (parts by mass) is controlled to be more than 800, preferably 990 or more, more preferably more than 1000, even more preferably 1120 or more, even more preferably more than 1200, even more preferably 1260 or more, even more preferably 1280 or more, even more preferably 1350 or more, even more preferably 1360 or more, and even more preferably 1440 or more. On the other hand, the upper limit is, for example, preferably less than 2000, more preferably less than 1800, even more preferably 1710 or less, even more preferably less than 1600, even more preferably less than 1560 or less, even more preferably 1530 or less, and even more preferably 1520 or less.

### 9. Relationship Between Rand Ratio and Acetone Extractable Content

The “land ratio” is a ratio of the actual contact area relative to a virtual contact area that would result from filling all the grooves on the surface of the tread. The land ratio is larger, the contact area with the road surface is larger so that the ground contact and the wet grip performance of the tire is improved.

On the other hand, if the acetone extractable content is large, the rubber composition for tread becomes softer and the contact area of the tread with the road surface increases, improving ground contact and improving the wet grip performance of the tire.

Considering the above, in the present invention, the product (La×AE) of the land ratio La and the acetone extractable content AE (mass %) is preferably more than 12.5, more preferably 13 or more, even more preferably 14 or more, even more preferably more than 15.0, even more preferably 16 or more, even more preferably 17 or more, and even more preferably more than 17.5. On the other hand, the upper limit is, for example, preferably less than 25.0, more preferably less than 22.5, even more preferably less than 20.0, even more preferably 19 or less, even more preferably 18 or less. As a result, wet grip performance of the tire is considered to be further improved.

The above-described land ratio can be determined from the ground contact shape under a standardized rim, a standardized internal pressure, and standardized load conditions.

Specifically, a tire is mounted on a standard rim, pressurized to a standardized internal pressure, and left at 25° C. for 24 hours. Then, ink is applied to the tread surface of the tire, and the tire is pressed against cardboard under a standardized load (at the camber angle) 0°. The tire is then rotated 72° circumferentially, and the printout is made at five locations. This means that five contact profiles are obtained. The grooves in the five contact profiles are made to be smoothly joined to obtain virtual contact surfaces as resulting shapes.

The land ratio can be calculated by dividing the average area of the five contact shapes (black portions) transferred onto the cardboard by the average area of the virtual contact surface obtained from the five contact shapes.

Here, a “standardized rim” refers to a rim that is determined for each tire by a standard system that includes a standard on which the tire is based. For example, in the case of JATMA (Japan Automobile Tire Manufacturers Association), this refers to a standardized rim for an applicable size listed in the “JATMA YEAR BOOK,” in the case of ETRTO (The European Tyre and Rim Technical Organization), this refers to the “Measuring Rim” listed in the “STANDARDS MANUAL,” and in the case of TRA (The Tire and Rim Association, Inc.), this refers to the “Design Rim” listed in the “YEAR BOOK”. Reference is made to JATMA, ETRTO, and TRA in that order, and if an applicable size is available at the time of reference, that standard is followed. In the case of tires not specified by the standard, it refers to a rim that can be mounted on a rim and can maintain internal pressure, i.e., a rim, at first, having the smallest rim diameter and, secondly, having the narrowest rim width, among rims that do not cause air leakage between the rim and the tire.

The “standardized internal pressure” refers to an air pressure specified for each tire by the standard. For JATMA, it refers to the maximum air pressure, for ETRTO, it refers to the “INFLATION PRESSURE” table, and for TRA, it refers to the maximum value listed in the “TIRE LOAD LIMITS AT VARIOUS COLD INFLATION PRESSURE” table. As with “standardized rim,” JATMA, ETRTO, and TRA are referenced in that order, and the standards are followed. For tires not specified by the standard, it refers to the standardized internal pressure (250 KPa or more) of another tire size (specified in the standard) that is specified using the standardized rim as the standardized rim. Note that if multiple standardized internal pressures of 250 KPa or more are specified, it refers to the smallest value among them.

Furthermore, the “standardized load” refers to a load specified for each tire by each standard in the standard system including a standard on which the tire is based, and refers to the maximum mass that can be loaded on the tire. In the case of JATMA, this refers to the maximum load capacity, in the case of ETRTO, it refers to the “LOAD CAPACITY,” and in the case of TRA, it refers to the maximum value listed in the table “TIRE LOAD LIMITS AT VARIOUS COLD INFLATION PRESSURES”. As with the above-mentioned “standardized rim” and “standardized internal pressure”, JATMA, ETRTO, and TRA are referenced in that order, and their standards are followed. In the case of a tire not specified in standards, the standardized load WL is found by the following calculation:

$$V = \{ {( D t / 2 )}^{2} - {( Dt / 2 - Ht )}^{2} \} \times Π \times Wt$$

$${W}_{L} = 0.000011 \times V + 175$$

WL: Standardized load (kg)
V: Virtual volume of tire (mm³)
Dt: Tire outer diameter Dt (mm)
Ht: Tire cross-sectional height (mm)
Wt: Tire cross-sectional width (mm)

### 9. Relationship Between Land Ratio and CTAB Specific Surface Area of Silica

In the present invention, the product (La×CTAB) of a land ratio La and a CTAB specific surface area (m²/g) of the silica is preferably more than 125. It is more preferably 130 or more, even more preferably more than 130, and even more preferably more than 135. On the other hand, the upper limit is, for example, preferably less than 170, more preferably less than 165, even more preferably less than 160, and even more preferably 159 or less, even more preferably 151 or less. As a result, wet grip performance of the tire is considered to be further improved.

When multiple types of silica are contained, the CTAB (average CTAB) in the above formula is calculated by dividing “the sum of products of “CTAB” and “the content (parts by mass) per 100 parts by mass of the total rubber component” for each types of silica” by “the total content (parts by mass) of silica per 100 parts by mass of the total rubber component”.

### 10. Relationship Between the Maximum Load Capacity and Weight of the Tire

The maximum load capacity of a tire refers to the load that can be supported by a single tire. It is believed that the steering stability at high-speed running is further improved by increasing the maximum load capacity relative to weight of the tire. The maximum load capacity WL (kg) of a tire can be calculated using the following formula based on the virtual volume V (mm³) of the tire described above.

$$WL ( kg ) = 0.000011 \times V + 175$$

In the present invention, the ratio (G/WL) of the weight G relative to the maximum load capacity WL of the tire is preferably 0.0170 or less, more preferably 0.0159 or less, even more preferably 0.0150 or less, even more preferably 0.0135 or less, and even more preferably 0.0130 or less. On the other hand, the lower limit is, for example, preferably 0.0100 or more, and more preferably 0.0110 or more.

### 11. Multi-Layered Tread

In the present invention, the tread portion may be composed of only one layer (a cap rubber layer) that forms the ground contact surface, may be composed of two layers having a base rubber layer provided inside the cap rubber layer, may be composed of three layers in which the cap rubber layer or the base rubber layer is multi-layered, or may be composed of four or more layers. In these cases, the rubber composition for tread refers to the rubber composition that forms the cap rubber layer that is the outermost layer provided on the ground contact surface side, and the cap rubber layer preferably satisfies each of the above parameters.

In this case, the thickness of the cap rubber layer in the entire tread is preferably 10% or more, more preferably 30% or more, even more preferably 50% or more, and even more preferably 70% or more.

### [3] Embodiment

The present invention is specifically described below based on embodiments.

### 1. Embodiment of a Tire According to the Present Invention

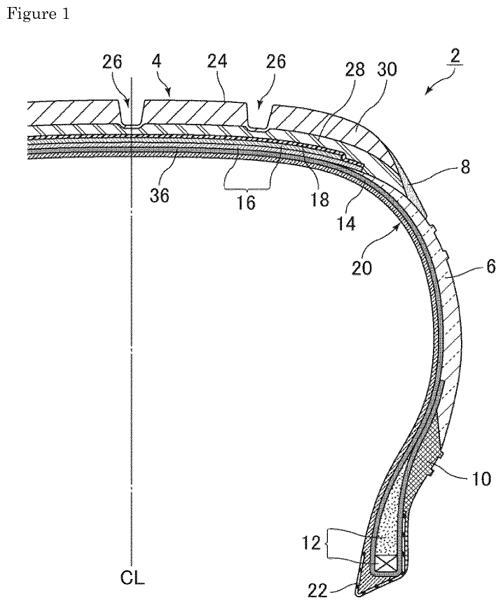

FIG. 1 is a schematic cross-sectional view illustrating a tire according to an embodiment.

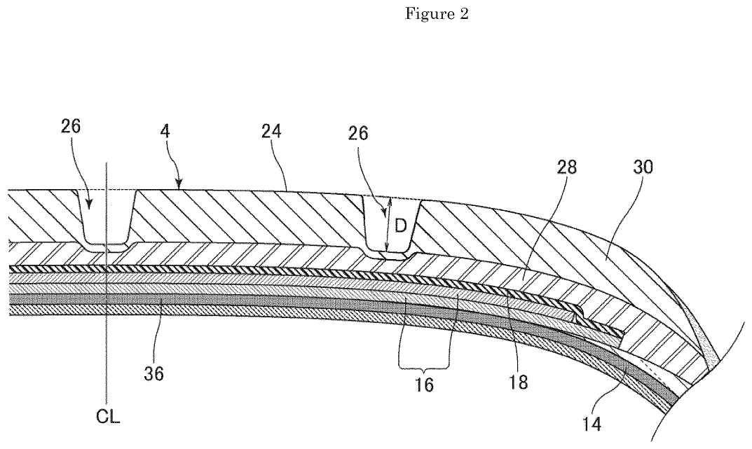

FIG. 2 is an enlarged cross-sectional view of the tire in FIG. 1 near the tread portion.

In FIG. 1, the up-down direction is a radial direction of the tire, the left-right direction is the direction of the rotational axis of the tire, and the direction perpendicular to the paper surface is the circumferential direction of the tire.

In FIGS. 1 and 2, the dashed-dotted line CL represents the equatorial plane of the tire.

Note that the shape of this tire is symmetrical with respect to the equatorial plane except for the tread pattern, and therefore FIG. 1 shows one-quarter of the entire tire.

As shown in FIGS. 1 and 2, the tire 2 includes a tread portion 4, a pair of sidewalls 6, a pair of wings 8, a pair of clinches 10, a pair of beads 12, a carcass 14, a belt 16, a band 18, an inner liner 20, and a pair of chafers 22, wherein the inner liner 20, the carcass 14, the belt 16, the band 18, and the tread portion 4 is arranged from the inside to the outside in a radial direction of the tire.

The tread portion 4 includes a cap rubber layer 30 and a base rubber layer 28, and main grooves 26 are arranged on the tread surface 24, with intervals in the axial direction. The carcass 14 includes carcass ply 36. In FIG. 2, the depth of the main grove is indicated by the symbol D.

In such a configuration, it is believed that, by appropriately controlling parameters such as the styrene content of the SBR as described above, it is possible to further improve wet grip performance of the tire.

In a tire according to the present invention, depth of the main groove is preferably 5 mm or more, and more preferably 7 mm or more, while the upper limit is preferably 12 mm or less, and more preferably 10 mm or less.

In a tire according to the present invention, the land ratio is preferably 0.55 or more, more preferably 0.60 or more, and even more preferably 0.65 or more, while the upper limit is preferably 0.75 or less, and more preferably 0.70 or less.

### 2. Rubber Composition Forming the Tread Portion

For a tire according to the present invention, the rubber composition forming the tread portion can be obtained by appropriately adjusting types and amounts of various compounding materials such as rubber components, fillers, plasticizer components, vulcanizing agents, and vulcanization accelerators described below.

### (1) Compounding Materials

### (a) Rubber Components

In the present invention, the rubber composition forming the tread portion contains, as described above, styrene-butadiene rubber (SBR) and an isoprene-based rubber as a rubber component. Other rubber components are not particularly limited, and rubbers (polymers) generally used in tire manufacturing can be used, such as diene-based rubbers such as butadiene rubber (BR) and nitrile rubber (NBR), a butyl-based rubbers such as butyl rubber, and thermoplastic elastomers such as styrene-butadiene-styrene block copolymer (SBS) and styrene-butadiene block copolymer (SB).

### (a) SBR

The weight average molecular weight of the SBR is, for example, more than 100,000 and less than 2,000,000. Styrene content, glass transition temperature, and vinyl content of the SBR are as described above.

In the present invention, the content of the SBR per 100 parts by mass of the total rubber component is preferably 50 parts by mass or more, more preferably 55 parts by mass or more, even more preferably 60 parts by mass or more, even more preferably 61 parts by mass or more, even more preferably 65 parts by mass or more, and even more preferably 70 parts by mass or more. On the other hand, the upper limit is preferably 95 parts by mass or less, more preferably 90 parts by mass or less, even more preferably 85 parts by mass or less, and even more preferably 80 parts by mass or less.

The SBR is not particularly limited, and for example, an emulsion polymerized styrene butadiene rubber (E-SBR), a solution polymerized styrene butadiene rubber (S-SBR), and the like can be used. The SBR may be either the non-modified SBR or a modified SBR. Further, a hydrogenated SBR obtained by hydrogenating a butadiene part in an SBR may be used. The hydrogenated SBR may be obtained by subsequently hydrogenating the butadiene part (BR part) in an SBR, or by obtaining a similar structure by copolymerization of styrene, ethylene, and butadiene.

The modified SBR is preferably an SBR having a functional group that interacts with a filler such as silica. Examples thereof include an end-modified SBR (end-modified SBR having the above functional group at the terminal) in which at least one end of the SBR is modified with a compound (modifying agent) having the above functional group, a main chain modified SBR having the functional group in the main chain, a main chain terminal modified SBR having the functional group at the main chain and the terminal (for example, a main chain end modified SBR having the above functional group to the main chain and having at least one end modified with the above modifying agent), and an end-modified SBR which is modified (coupled) with a polyfunctional compound having two or more epoxy groups in the molecule to be introduced with an epoxy group or a hydroxyl group.

Examples of the functional group include an amino group, an amide group, a silyl group, an alkoxysilyl group, an isocyanate group, an imino group, an imidazole group, an urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxyl group, a nitrile group, a pyridyl group, an alkoxy group, a hydroxyl group, an oxy group, and an epoxy group. In addition, these functional groups may have a substituent.

As the modified SBR, for example, SBR modified with a compound (modifying agent) represented by the following formula can be used.

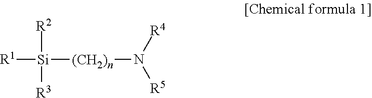

In the formula, R¹, R² and R³ are the same or different, and each represents an alkyl group, an alkoxy group, a silyloxy group, an acetal group, a carboxyl group (—COOH), a mercapto group (—SH), or a derivative thereof. R⁴ and R⁵ are the same or different, and reach represents a hydrogen atom, or an alkyl group. R⁴ and R⁵ may be combined to form a ring structure together with a nitrogen atom. Represented by n is an integer.

As the modified SBR modified by a compound (modifying agent) represented by the above formula, SBR, in which the polymerization end (active end) of the solution-polymerized styrene-butadiene rubber (S-SBR) is modified by a compound represented by the above formula (for example, modified SBR described in JP-A-2010-111753), can be used.

R¹, R² and R³ are preferably alkoxy groups (preferably alkoxy groups preferably having 1 to 8 carbon atoms, more preferably 1 to 4 carbon atoms). R⁴ and R⁵ are preferably alkyl groups (preferably alkyl groups having 1 to 3 carbon atoms). Preferably, n is 1 to 5, more preferably 2 to 4, and further preferably 3. When R⁴ and R⁵ bond to form a ring structure together with a nitrogen atom, it is preferred to form a 4- to 8-membered ring. Incidentally, the alkoxy groups also may be cycloalkoxy groups (cyclohexyloxy groups, etc.) and aryloxy groups (phenoxy groups, benzyloxy groups, etc.).

Specific examples of the above modifying agent include 2-dimethylaminoethyltrimethoxysilane, 3-dimethylaminopropyltrimethoxysilane, 2-dimethylaminoethyltriethoxysilane, 3-dimethylaminopropyltriethoxysilane, 2-diethylaminoethyltrimethoxysilane, 3-diethylaminopropyltrimethoxysilane, 2-diethylaminoethyltriethoxysilane, and 3-diethylaminopropyltriethoxysilane. These may be used alone or in combination of two or more.

Further, as the modified SBR, a modified SBR modified with the following compound (modifying agent) can also be used. Examples of the modifying agent include polyglycidyl ethers of polyhydric alcohols such as ethylene glycol diglycidyl ether, glycerin triglycidyl ether, trimethylolethanetriglycidyl ether, and trimethylolpropane triglycidyl ether; polyglycidyl ethers of aromatic compounds having two or more phenol groups such as diglycidylated bisphenol A; polyepoxy compounds such as 1,4-diglycidylbenzene, 1,3,5-triglycidylbenzene, and polyepoxidized liquid polybutadiene; epoxy group-containing tertiary amines such as 4,4′-diglycidyl-diphenylmethylamine, and 4,4′-diglycidyl-dibenzylmethylamine; diglycidylamino compounds such as diglycidylaniline, N,N′-diglycidyl-4-glycidyloxyaniline, diglycidyl orthotoluidine, tetraglycidyl meta xylene diamine, tetraglycidylaminodiphenylmethane, tetraglycidyl-p-phenylenediamine, diglycidylaminomethylcyclohexane, and tetraglycidyl-1,3-bisaminomethylcyclohexane; amino group-containing acid chlorides such as bis-(1-methylpropyl) carbamate chloride, 4-morpholincarbonyl chloride, 1-pyrrolidincarbonyl chloride, N, N-dimethyl carbamide acid chloride, and N, N-diethylcarbamide acid chloride; epoxy group-containing silane compounds such as 1,3-bis-(glycidyloxypropyl)-tetramethyldisiloxane, and (3-glycidyloxypropyl)-pentamethyldisiloxane; sulfide group-containing silane compound such as (trimethylsilyl) [3-(trimethoxysilyl) propyl] sulfide, (trimethylsilyl) [3-(triethoxysilyl) propyl] sulfide, (trimethylsilyl) [3-(tripropoxysilyl) propyl] sulfide, (trimethylsilyl) [3-(tributoxysilyl) propyl] sulfide, (trimethylsilyl) [3-(methyldimethoxysilyl) propyl] sulfide, (trimethylsilyl) [3-(methyldiethoxysilyl) propyl] sulfide, (trimethylsilyl) [3-(methyldipropoxysilyl) propyl] sulfide, and (trimethylsilyl) [3-(methyldibutoxysilyl) propyl] sulfide; N-substituted aziridine compound such as ethyleneimine and propylene imine; alkoxysilanes such as methyltriethoxysilane, N, N-bis(trimethylsilyl)-3-aminopropyltrimethoxysilane, N, N-bis(trimethylsilyl)-3-aminopropyltriethoxysilane, N, N-bis(trimethylsilyl) aminoethyltrimethoxysilane, and N, N-bis(trimethylsilyl) aminoethyltriethoxysilane; (thio) benzophenone compound having an amino group and/or a substituted amino group such as 4-N, N-dimethylaminobenzophenone, 4-N, N-di-t-butyl amino benzophenone, 4-N, N-diphenyl amino benzophenone, 4,4′-bis(dimethyl amino)benzophenone, 4,4′-bis(diethylamino)benzophenone, 4,4′-bis(diphenyl amino)benzophenone, and N, N,N′, N′-bis-(tetraethyl amino)benzophenone; benzaldehyde compounds having an amino group and/or a substituted amino group such as 4-N, N-dimethylaminobenzaldehyde, 4-N, N-diphenylaminobenzaldehyde, and 4-N, N-divinyl amino benzaldehyde; N-substituted pyrrolidone such as N-methyl-2-pyrrolidone, N-vinyl-2-pyrrolidone, N-phenyl-2-pyrrolidone, N-t-butyl-2-pyrrolidone, and N-methyl-5-methyl-2-pyrrolidone; N-substituted piperidone such as methyl-2-piperidone, N-vinyl-2-piperidone, and N-phenyl-2-piperidone; N-substituted lactams such as N-methyl-ε-caprolactam, N-phenyl-ε-caprolactam, N-methyl-ω-laurylolactam, N-vinyl-ω-laurylolactam, N-methyl-ß-propiolactam, and N-phenyl-ß-propiolactam; and N, N-bis-(2,3-epoxypropoxy)-aniline, 4,4-methylene-bis-(N, N-glycidyl aniline), tris-(2,3-epoxypropyl)-1,3,5-triazine-2,4,6-triones, N, N-diethyl acetamide, N-methylmaleimide, N, N-diethyl urea, 1,3-dimethylethylene urea, 1,3-divinylethyleneurea, 1,3-diethyl-2-imidazolidinone, 1-methyl-3-ethyl-2-imidazolidinone, 4-N, N-dimethyl aminoacetophenone, 4-N, N-diethyl amino acetophenone, 1,3-bis(diphenyl amino)-2-propanone, and 1,7-bis(methylethylamino)-4-heptanone. The modification with the above compound (modifying agent) can be carried out by a known method.

As the SBR, for example, SBR manufactured and sold by Sumitomo Chemical Co., Ltd., ENEOS Materials Corporation, Asahi Kasei Corporation, Zeon corporation, LG Chemical Co., Ltd., etc. can be used. Note that SBR may be used alone or in combination of two or more.

### (b) Isoprene Rubber

Examples of the isoprene-based rubber include natural rubber (NR), a modified natural rubber (modified NR), a denatured natural rubber (denatured NR), a synthetic polyisoprene (an isoprene rubber (IR)), and a denatured isoprene rubber (denatured IR). Among these examples, NR is preferred because of its excellent strength. The content of the isoprene-based rubber per 100 parts by mass of the total rubber component is as described above.

Specific examples of NR that can be used include those commonly used in the tire industry, such as SIR20, RSS #3, TSR20, and SVR-L. A modified NR and a denatured NR may also be used. The modified NR includes a deproteinized natural rubber (DPNR) and a highly purified natural rubber (UPNR), while the denatured NR includes an epoxidized natural rubber (ENR), a hydrogenated natural rubber (HNR), and grafted natural rubber.

The IR is not particularly limited, and for example, IR2200 or other commonly used IR in the tire industry can be used. A modified IR may also be used. Examples of the modified IR include an epoxidized isoprene rubber, a hydrogenated isoprene rubber, and a grafted isoprene rubber. These may be used alone or in combination of two or more.

### (c) BR

In the present invention, the rubber composition may contain BR as needed. In this case, the amount of BR per 100 parts by mass of the total rubber component is preferably 10 parts by mass or more, more preferably 15 parts by mass or more, even more preferably 20 parts by mass or more, and even more preferably 30 parts by mass or more. On the other hand, the upper limit is, for example, preferably 50 parts by mass or less, more preferably 45 parts by mass or less, and even more preferably 40 parts by mass or less.

The average molecular weight of the BR is, for example, more than 100,000 and less than 2,000,000. The vinyl content of the BR is, for example, more than 1 mass % and less than 30 mass %. The cis content of the BR is, for example, more than 1 mass % and less than 98 mass %. The trans content of the BR is, for example, more than 1 mass % and less than 60 mass %. The cis content can be measured by an infrared absorption spectroscopy.

As the BR, a BR with a high cis content (cis content of 90% or more), a BR with a low cis content or a BR containing syndiotactic polybutadiene crystals, for example, may be used without specific limitation. The BR may be either an unmodified BR or a modified BR. As the modified BR, for example, BR modified with a compound (modifying agent) represented by the following formula can be used.

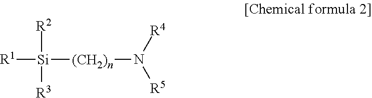

In the formula, R¹, R² and R³ are the same or different, and each represents an alkyl group, an alkoxy group, a silyloxy group, an acetal group, a carboxyl group (—COOH), a mercapto group (—SH), or a derivative thereof. R⁴ and R⁵ are the same or different, and reach represents a hydrogen atom, or an alkyl group. R⁴ and R⁵ may be combined to form a ring structure together with a nitrogen atom. Represented by n is an integer.

Examples of the modified BR modified with a compound (a modifying agent) represented by the above formula include a BR whose polymerization end (an active end) is modified with a compound represented by the above formula.

R¹, R² and R³ are preferably alkoxy groups (preferably alkoxy groups having 1 to 8 carbon atoms, more preferably 1 to 4 carbon atoms), respectively. R⁴ and R⁵ are preferably alkyl groups (preferably alkyl groups having 1 to 3 carbon atoms), respectively. Preferably n is 1 to 5, more preferably 2 to 4, and even more preferably 3. When R⁴ and R⁵ combine to form a ring structure together with a nitrogen atom, they form a 4- to 8-membered ring preferably. Incidentally, the alkoxy groups also include cycloalkoxy groups (cyclohexyloxy group, etc.) and aryloxy groups (phenoxy group, benzyloxy group, etc.).

Specific examples of the modifying agent include 2-dimethylaminoethyltrimethoxysilane, 3-dimethylaminopropyltrimethoxysilane, 2-dimethylaminoethyltriethoxysilane, 3-dimethylaminopropyltriethoxysilane, 2-diethylaminoethyltrimethoxysilane, 3-diethylaminopropyltrimethoxysilane, 2-diethylaminoethyltriethoxysilane, 3-diethylaminopropyltriethoxysilane, etc. These may be used alone or in combination of two or more.

In addition, a modified BR modified by the following compound (modifying agent) can also be used as the modified BR. The modifying agent may be, for example, a polyglycidyl ether of a polyalcohol such as ethylene glycol diglycidyl ether, glycerin triglycidyl ether, trimethylolethanetriglycidyl ether, or trimethylolpropanetriglycidyl ether; a polyglycidyl ether of an aromatic compound having two or more phenolic groups, such as diglycidylated bisphenol A; a polyepoxy compound such as 1,4-diglycidylbenzene, 1,3,5-triglycidylbenzene, polyepoxy liquid polybutadiene; a tertiary amine containing an epoxy group such as 4,4′-diglycidyl diphenylmethylamine, 4,4′-diglycidyl dibenzylmethylamine, a diglycidylamino compound such as diglycidyl aniline, N,N′-diglycidyl-4-glycidyloxyaniline, diglycidyl orthotoluidine, tetraglycidyl methaxylene diamine, tetraglycidylaminodiphenylmethane, tetraglycidyl-p-phenylenediamine, diglycidylaminomethylcyclohexane, tetraglycidyl-1,3-bis-amino methoxy cyclohexane; a chloride containing amino groups such as bis-(1-methylpropyl) carbamate, 4-morpholine carbonyl chloride, 1-pyrrolidine carbonyl chloride, N,N-dimethyl carbamate chloride, N,N-diethyl carbamide chloride; an epoxy-containing silane compound such as 1,3-bis-(glycidyloxypropyl)-tetramethyl disiloxane, (3-glycidyloxypropyl)-pentamethyldisiloxane, a sulfide-containing silane compound such as (trimethylsilyl) [3-(trimethoxysilyl) propyl] sulfide, (trimethylsilyl) [3-(triethoxysilyl) propyl] sulfide, (trimethylsilyl) [3-(tripropoxysilyl) propyl] sulfide, (trimethylsilyl) [3-(tributoxysilyl) propyl] sulfide, (trimethylsilyl) [3-(methyldimethoxysilyl) propyl] sulfide, (trimethylsilyl) [3-(methyldiethoxysilyl) propyl] sulfide, (trimethylsilyl) [3-(methyldipropoxysilyl) propyl] sulfide, (trimethylsilyl) [3-(methyldibutoxysilyl) propyl] sulfide; an N-substituted aziridine compounds such as ethyleneimine and propyleneimine; an alkoxysilane such as methyltriethoxysilane, N,N-bis(trimethylsilyl)-3-aminopropyltrimethoxysilane, N,N-bis(trimethylsilyl)-3-aminopropyltriethoxysilane, N,N-bis(trimethylsilyl) aminoethyltrimethoxysilane, N,N-bis(trimethylsilyl) aminoethyltriethoxysilane; a (thio) benzophenone compound with an amino group and/or a substituted amino group such as 4-N,N-dimethylaminobenzophenone, 4-N,N-di-t-butylaminobenzophenone, 4-N,N-diphenylamino benzophenone, 4,4′-bis(dimethylamino)benzophenone, 4,4′-bis(diethylamino)benzophenone, 4,4′-bis(diphenylamino)benzophenone, N,N,N′,N′-bis-(tetraethylamino)benzophenone; a benzaldehyde compounds with an amino group and/or a substituted amino group, such as 4-N,N-dimethylaminobenzaldehyde, 4-N,N-diphenylaminobenzaldehyde, 4-N,N-divinylamino benzaldehyde; an N-substituted pyrrolidone such as N-methyl-2-pyrrolidone, N-vinyl-2-pyrrolidone, N-phenyl-2-pyrrolidone, N-t-butyl-2-pyrrolidone, N-methyl-5-methyl-2-pyrrolidone; an N-substituted piperidone such as N-methyl-2-piperidone, N-vinyl-2-piperidone, N-phenyl-2-piperidone; an N-substituted lactams such as N-methyl-ε-caprolactam, N-phenyl-ε-caprolactam, N-methyl-ω-laurylolactam, N-vinyl-ω-laurylolactam, N-methyl-ß-propiolactam, N-phenyl-6-propiolactam; in addition, N,N-bis-(2,3-epoxypropoxy)-aniline, 4,4-methylene-bis-(N,N-glycidylaniline), tris-(2,3-epoxypropyl)-1,3,5-triazine-2,4,6-triones, N,N-diethylacetamide, N-methylmaleimide, N,N-dimethyl urea, 1,3-dimethylethylene urea, 1,3-divinylethyleneurea, 1,3-diethyl-2-imidazolidinone, 1-methyl-3-ethyl-2-imidazolidinone, 4-N,N-dimethylaminoacetophenone, 4-N,N-diethylaminoacetophenone, 1,3-bis(diphenylamino)-2-propanone, 1,7-bis(methylethylamino)-4-heptanone, etc. In addition, modification with the above compound (modifying agent) can be performed by a publicly known method. Such a modified BR may be used alone or in combination with two or more types.

As the BR, for example, products of UBE Corporation., ENEOS Materials Corporation, Asahi Kasei Corporation, Zeon Corporation, etc. can be used.

### (iv) Other Rubber Components

Further, other rubber components may include rubbers (polymers) that are generally used in the manufacture of tires, such as nitrile rubber (NBR).

The raw materials (monomers) of the above-mentioned synthetic rubbers such as SBR and BR may be derived from petroleum or may be recycled from rubber products such as tires or non-rubber products such as polystyrene.

Monomers obtained by recycling (recycled monomers) are not particularly limited, and examples thereof include recycled butadiene, and recycled aromatic vinyl. Examples of the above-mentioned butadiene include 1,2-butadiene and 1,3-butadiene. Examples of the aromatic vinyl include, but are not particularly limited to, styrene. Among them, it is preferable to use recycle-derived recycle-derived butadiene (recycled butadiene), and/or recycle-derived styrene (recycled styrene) as raw materials.

The method for producing the recycled monomer is not particularly limited, and examples thereof include synthesis from recycled naphtha obtained by decomposing rubber products such as tires. The method for producing recycled naphtha is also not particularly limited, and examples thereof include decomposing rubber products such as tires under high temperature and pressure, decomposing with microwaves, or mechanically crushing and then extracting.

Furthermore, the raw materials (monomers) of synthetic rubbers such as SBR, and BR may be derived from biomass. Examples of monomers derived from biomass (biomass monomers) include, but are not limited to, butadiene derived from biomass and aromatic vinyl derived from biomass. Examples of butadiene include 1,2-butadiene and 1,3-butadiene. Examples of aromatic vinyl include, but are not limited to, styrene. In addition, the method for producing biomass monomers is not particularly limited, and examples include biological and/or chemical and/or physical conversion of animals and plants. A representative example of biological conversion is fermentation by microorganisms, and examples of chemical and/or physical conversion include those using catalysts, those using high heat, those using high pressure, those using electromagnetic waves, those using critical liquids, and combinations thereof. The resources of Biomass refer to substances derived from natural resources such as plants. Examples of resources of the biomass include, but are not limited to, sugar, wood chips, plant residues after useful components are obtained, plant-derived ethanol, and biomass naphtha.

The polymer synthesized from a biomass monomer component (biomass polymer) is not particularly limited, and examples thereof include polybutadiene rubber synthesized from butadiene derived from biomass, aromatic vinyl/butadiene copolymer synthesized from butadiene derived from biomass and/or aromatic vinyl derived from biomass, etc. Examples of the aromatic vinyl/butadiene copolymer include styrene butadiene rubber synthesized from butadiene derived from biomass and/or styrene derived from biomass.

Whether the raw material of a polymer is derived from biomass can be determined by the percent modern carbon (pMC) measured in accordance with ASTM D6866-10.

The pMC is a ratio of the ¹⁴C concentration of a sample to the ¹⁴C concentration of a modern standard reference, and this value is used as an index of the biomass ratio of a compound (rubber). The significance of this value is described below.

In one mole of carbon atoms (6.02×10²³), there are about 6.02×10^{11 14}C, which is about one trillionth of the number of normal carbon atoms. 14C is called a radioisotope, and its half-life is 5730 years, and it decreases regularly. It takes 226,000 years for all of them to decay. Therefore, in fossil fuels such as coal, oil, and natural gas, which are thought to have passed more than 226,000 years after carbon dioxide in the atmosphere was absorbed and fixed to plants and other things, all of the 14C elements that were contained in them at the time of fixation have decayed. Therefore, in the present 21st century, fossil fuels such as coal, oil, and natural gas do not contain any ¹⁴C elements at all. Therefore, chemical substances produced using these fossil fuels as raw materials do not contain any ¹⁴C elements at all.

On the other hand, ¹⁴C is constantly produced by nuclear reactions caused by cosmic rays in the atmosphere, and the amount of ¹⁴C in the atmospheric environment on Earth is constant, balancing with decrease due to radioactive decay. Therefore, ¹⁴C concentration of materials derived from biomass resources circulating in the current environment is approximately 1×10-12 mol % with respect to the total C atoms, as mentioned above. Therefore, difference between these values can be used to calculate a ratio (biomass ratio) of compounds derived from natural resources (compounds derived from biomass resources) in a certain compound (rubber).

This ¹⁴C is generally measured as follows. Accelerator mass spectrometry based on a tandem accelerator is used to measure the ¹³C concentration (¹³C/¹²C) and the ¹⁴C concentration (¹⁴C/¹²C). In the measurement, the ¹⁴C concentration in circulating carbon in nature as of 1950 is adopted as the modern standard reference for the ¹⁴C concentration. As a specific standard substance, an oxalic acid standard provided by NIST (National Institute of Standards and Technology) is used. The specific radioactivity of carbon (radioactivity of ¹⁴C per gram of carbon) in this oxalic acid is separated for each carbon isotope, and ¹³C is corrected to a constant value, and the value corrected for decay from 1950 to the date of measurement is used as the standard ¹⁴C concentration value (100%). The ratio of this value to the value of the actual measured sample is the pMC value.

Therefore, if rubber is made from 100% biomass (natural) derived materials, it will show a value of about 110 pMC, as it is often not 100 under normal conditions, although there are regional differences. On the other hand, when the ¹⁴C concentration is measured for chemical substances derived from fossil fuels such as petroleum, it will show a value of about 0 pMC (for example, 0.3 pMC). This value corresponds to the biomass ratio of 0% mentioned above.

For the above reasons, it is preferable from the standpoint of environmental protection and enhancing sustainability to use a material such as rubber having a high pMC value, that is, a material such as rubber having a high biomass ratio for the rubber composition.

(b) Compounding Materials Other than Rubber Components
(b-1) Filler

As described above, the rubber composition constituting a tread in the present invention preferably contains silica as a filler, and may contain other fillers, such as carbon black, graphite, calcium carbonate, talc, alumina, clay, aluminum hydroxide, and mica. It is preferable to use a silane coupling agent in combination with the silica.

(i-1) Silica

The content and preferred CTAB of the silica in the rubber composition are as described above.

BET specific surface area of the silica is preferably more than 140 m²/g, more preferably more than 160 m²/g, from the viewpoint of obtaining good durability. On the other hand, from the viewpoint of obtaining good rolling resistance during high-speed running, it is preferably less than 250 m²/g, more preferably less than 220 m²/g. Noto that the BET specific surface area is the N₂SA value measured by the BET method in accordance with ASTM D3037-93.

Examples of the silica include a silica made by a dry-process (anhydrous silica) and a silica made by a wet-process (hydrated silica). Among them, the silica obtained by a wet-process is preferred because it has many silanol groups. A silica made from hydrous glass or a silica made from biomass materials such as rice husks may also be used.

As commercially available silica, for example, products from Evonik Industries AG, Rhodia, Tosoh Silica Corporation, Solvay Japan Co., Ltd., Tokuyama Corporation, etc. can be used.

The raw material of silica is not particularly limited, and is, for example, a mineral-derived raw material such as quartz, a biological raw material such as rice husk (for example, silica made from biomass materials such as rice husk), or silica recycled from a product containing silica. Among them, hydrated silica prepared by a wet method is preferred because it has a large amount of silanol groups.

Silica made from biomass materials can be obtained, for example, by extracting silicate from rice husk ash obtained by burning rice husks using a sodium hydroxide solution, and then reacting the silicate with sulfuric acid in the same manner as conventional wet-process silica to produce a silicon dioxide precipitate, which is then filtered, washed with water, dried, and pulverized.

The silica recycled from a product containing silica can be, for example, silica recycled from a product containing silica, such as electronic parts such as semiconductors, tires, desiccants, and filtering materials such as diatomaceous earth. The recycle method is not particularly limited, and examples include pyrolysis and decomposition by electromagnetic waves. Among them, silica recycled from electronic parts such as semiconductors or tires is preferred.

When silica crystallizes, it does not dissolve in water, and its component silicic acid cannot be used. By controlling the combustion temperature and combustion time, the crystallization of silica in rice husk ash can be suppressed (see JP 2009-2594 A, Akita Prefectural University Web Journal B/2019, vol. 6, pp. 216-222, etc.).

As an amorphous silica extracted from rice husks, commercially available products from Wilmar Co., etc. can be used.

Such a silica may be used alone or in combination of two or more. The use of biomass silica or recycled silica is preferred from the viewpoint of contributing to environmental protection and improving sustainability.

(i-2) Silane Coupling Agent

As described above, when silica is used, it is preferable to use a silane coupling agent in combination with silica.

The silane coupling agent is not particularly limited, and examples thereof include a sulfide-based silane coupling agent such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl) tetrasulfide, bis(2-trimethoxysilylethyl) tetrasulfide, bis(2-triethoxysilylethyl)trisulfide, bis(4-trimethoxysilylbutyl) trisulfide, bis(3-triethoxysilylpropyl)disulfide, bis(2-triethoxysilylethyl) disulfide, bis(4-triethoxysilylbutyl)disulfide, bis(3-trimethoxysilylpropyl) disulfide, bis(2-trimethoxysilylethyl)disulfide, bis(4-trimethoxysilylbutyl)disulfide, 3-trimethoxysilylpropyl-N, N-dimethylthiocarbamoyltetrasulfide, 2-triethoxysilylethyl-N, N-dimethylthiocarbamoyltetrasulfide, or 3-triethoxysilylpropylmethacrylatemonosulfide; a mercapto-based silane coupling agent such as 3-mercaptopropyltrimethoxysilane, 2-mercaptoethyltriethoxysilane, and NXT and NXT-Z manufactured by Momentive; vinyl-based ones such as vinyl triethoxysilane, and vinyl trimethoxysilane; amino-based ones such as 3-aminopropyltriethoxysilane or 3-aminopropyltrimethoxysilane; a glycidoxy-based silane coupling agent such as γ-glycidoxypropyltriethoxysilane or γ-glycidoxypropyltrimethoxysilane; a nitro-based silane coupling agent such as 3-nitropropyltrimethoxysilane, or 3-nitropropyltriethoxysilane; and a chloro-based silane coupling agent such as 3-chloropropyltrimethoxysilane or 3-chloropropyltriethoxysilane. These may be used alone or in combination of two or more types. In the present invention, it is preferable to contain, as the silane coupling agent, the mercapto-based silane coupling agent.

As commercially available silane coupling agents, for example, products from Evonik Industries AG, Momentive Performance Materials Worldwide LLC, Shin-Etsu Silicones Co., Ltd., Tokyo Chemical Industry Co., Ltd., Azumax Co., Ltd., Dow Corning Toray, etc. can be used.

The content of the silane coupling agent is, for example, preferably more than 3 parts by mass, more preferably more than 9.7 parts by mass, even more preferable 10 parts by mass or more, relative to 100 parts by mass of silica, while the upper limit is preferably less than 25 parts by mass.

### (ii) Carbon Black

In the present invention, the rubber composition preferably contains carbon black from the viewpoint of reinforcement.

The specific content of carbon black per 100 parts by mass of the total rubber component is preferably 5 parts by mass or more, and more preferably 10 parts by mass or more, while the upper limit is, for example, preferably 30 parts by mass or less, and more preferably 20 parts by mass or less.

The carbon black is not particularly limited, and examples thereof include a furnace black (furnace carbon black) such as SAF, ISAF, HAF, MAF, FEF, SRF, GPF, APF, FF, CF, SCF, or ECF; an acetylene black (acetylene carbon black); a thermal black (thermal carbon black) such as FT or MT; and a channel black (channel carbon black) such as EPC, MPC, or CC. These may be used alone or in combination of two or more.

The CTAB specific surface area of the carbon black is preferably 130 m²/g or more, more preferably 160 m²/g or more, and even more preferably 170 m²/g or more. On the other hand, the upper limit is, for example, preferably 250 m²/g or less, and more preferably 200 m²/g or less. The CTAB specific surface area is a value measured in accordance with ASTM D3765-92.

Specific carbon black is not particularly limited, and examples thereof include N134, N110, N220, N234, N219, N339, N330, N326, N351, N550, and N762. As commercially available products, products of Asahi Carbon Co., Ltd., Cabot Japan Co., Ltd., Tokai Carbon Co., Ltd., Mitsubishi Chemical Co., Ltd., Lion Corporation, Nippon Steel Carbon Co., Ltd., Columbia Carbon Co., Ltd., etc. can be used. These may be used alone or in combination of two or more kinds.

(iii) Other Fillers

In addition to carbon black and silica described above, the rubber composition may further contain, as necessary, a filler commonly used in the tire industry, such as graphite, calcium carbonate, talc, alumina, clay, aluminum hydroxide, or mica. The content of such a filler may be, for example, more than 0.1 parts by mass and less than 200 parts by mass per 100 parts by mass of the total rubber component.

(b-2) Plasticizer Component

Considering appropriate dispersion of powder materials during kneading, it is preferable to use a plasticizer component for the rubber composition as needed. The plasticizer component here refers to a component that plasticizes the rubber composition, such as a process oil, a rubber component extender, a liquid rubber, or a resin component, and may be extracted from the vulcanized rubber with acetone.

The plasticizer component may be derived from petroleum, may be derived from biomass, or may be derived from naphtha recycled from a rubber product or a non-rubber product. In addition, low molecular weight hydrocarbon components obtained by pyrolysis and extraction of used tires or products containing various components may be used as the plasticizer component. Among these, a plasticizer component derived from biomass or recycled materials is preferred as a sustainable plasticizer component.

The plasticizer component may be used alone or in combination of two or more. In this case, the content of the plasticizer component per 100 parts by mass of the total rubber component is preferably 20 parts by mass or more, more preferably 30 parts by mass or more, and even more preferably 40 parts by mass or more. On the other hand, the upper limit is, for example, preferably 100 parts by mass or less, more preferably 99 parts by mass or less, even more preferably 97.25 parts by mass or less, even more preferably 96 parts by mass or less, even more preferably 95.25 parts by mass or less, even more preferably 94 parts by mass or less, even more preferably 93.25 parts by mass or less, even more preferably 80 parts by mass or less, even more preferably 79 parts by mass or less, even more preferably 72 parts by mass or less, even more preferably 70 parts by mass or less, even more preferably 68 parts by mass or less, and even more preferably 60 parts by mass or less.

The content of the plasticizer component also includes the amount of oil contained in the rubber (oil-extended rubber) and the like.

### (i) Oil

Examples of oil include mineral oil (generally referred to as process oil), vegetable oil, and a mixture thereof. Among these, the vegetable oil is preferred because it has a high molecular weight and is therefore more likely to be inhibited from migrating, for example, at an interface of the rubber layers.

Specific examples of the mineral oil (process oil) include a paraffinic process oil such as Mild Extract Solvated (MES), Distillate Aromatic Extract (DAE), Treated Distillate Aromatic Extract (TDAE), Treated Residual Aromatic Extract (TRAE), or Residual Aromatic Extract (RAE), an aromatic process oil, and a naphthenic process oil.

Examples of the vegetable oil include a castor oil, a cottonseed oil, a linseed oil, a rapeseed oil, a soybean oil, a palm oil, a coconut oil, a peanut oil, rosin oil, a pine oil, a pine tar, a tall oil, a corn oil, a rice bran oil, a safflower oil, a sesame oil, an olive oil, a sunflower oil, a palm kernel oil, a camellia oil, a jojoba oil, a macadamia nut oil, or a tung oil. These examples may be used alone or in combination of two or more. From the viewpoint of the life cycle assessment, waste oil used as a lubricant in a rubber mixer or an automobile engine, etc., and a waste cooking oil may also be used as appropriately.

The oil content, per 100 parts by mass of the total rubber component, is preferably 5 parts by mass or more, more preferably 15 parts by mass or more, even more preferably 16.05 parts by mass or more, even more preferably 16.25 parts by mass or more, even more preferably 18 parts by mass or more, and even more preferably 20 parts by mass or more, even more preferably 26 parts by mass or more, even preferably 26.25 parts by mass or more, even preferably 29 parts by mass or more, even preferably 29.25 parts by mass or more. On the other hand, the upper limit is preferably 70 parts by mass or less, more preferably 50 parts by mass or less, even more preferably 49 parts by mass or less, even more preferably 44 parts by mass or less, even more preferably 43.25 parts by mass or less, even more preferably 42 parts by mass or less, even more preferably 40 parts by mass or less, even more preferably 39 parts by mass or less, even more preferably 37.25 parts by mass or less, even more preferably 36 parts by mass or less, even more preferably 35.25 parts by mass or less, even more preferably 35 parts by mass or less, and even more preferably 30 parts by mass or less.

Specific examples of the process oil (mineral oil) that may be used include products from Idemitsu Kosan Co., Ltd., Sankyo Yuka Kogyo K. K., ENEOS Materials Corporation, Orisoi Corporation, H&R Corporation, Toyokuni Oil Mills Co., Ltd., Showa Shell Sekiyu K.K., Fuji Kosan Co., Ltd., and the like.

### (ii) Liquid Rubber

Liquid rubber mentioned above as plasticizer, is a polymer that is in a liquid state at room temperature (25° C.), and is a rubber component that can be extracted from a vulcanized tire by acetone extraction. Examples of the liquid rubber include a farnesene-based polymer (liquid farnesene polymer), a liquid diene polymer, and a hydrogenated product thereof.

The farnesene-based polymer is a polymer obtained by polymerizing farnesene, and has a structural unit based on farnesene. Farnesene includes isomers such as α-farnesene ((3E, 7E)-3,7,11-trimethyl-1,3,6,10-dodecatetraene) and 8-farnesene (7,11-dimethyl-3-methylene-1, 6,10-dodecatrien).

The farnesene-based polymer may be a homopolymer of farnesene (farnesene homopolymer) or a copolymer of farnesene and a vinyl monomer (farnesene-vinyl monomer copolymer).

Examples of the liquid diene polymer include a liquid styrene-butadiene copolymer (liquid SBR), a liquid butadiene polymer (liquid BR), a liquid isoprene polymer (liquid IR), and a liquid styrene isoprene copolymer (liquid SIR).

The liquid diene polymer has a polystyrene-equivalent weight average molecular weight (Mw) measured by gel permeation chromatography (GPC) of, for example, more than 1.0×10³ and less than 2.0×10⁵. In this specification, Mw of the liquid diene polymer is a polystyrene conversion value measured by gel permeation chromatography (GPC).

The content of the liquid rubber (total content of the liquid farnesene polymer, the liquid diene polymer, etc.) is preferably more than 1 part by mass, more preferably more than 5 parts by mass, and even more preferably 10 parts by mass or more, per 100 parts by mass of the total rubber component, while the upper limit is, for example, preferably less than 25 parts by mass, more preferably less than 20 parts by mass, and even more preferably less than 15 parts by mass.

As commercially available liquid rubber, for example, products from Kuraray Co., Ltd., Cray Valley Co., Ltd., etc. can be used.

(iii) Resin Component

The resin component may also have functions as a tackifying component, and may be solid or liquid at room temperature. Specific examples of the resin component, even may overlap depending on the classification method, include an aromatic resin, a dicyclopentadiene resin, a terpene resin, a rosin-based resin, a styrene resin, a coumaron-based resin, a C5 resin, a C9 resin, a C5C9 resin, or an acrylic resin, and two or more of these may be used in combination. Such a resin component may be provided with a modified group capable of reacting with silica, etc., as necessary. The content of the resin component per 100 parts by mass of the total rubber component is as described above.

Rosin-based resin is a resin whose main component is rosin acid obtained by processing pine resin. This rosin-based resin (rosins) can be classified according to the presence or absence of modification, and can be classified into unmodified rosin (unmodified rosin) and modified rosin (rosin derivative). Examples of unmodified rosin include tall rosin (also known as tall oil rosin), gum rosin, wood rosin, disproportionated rosin, polymerized rosin, hydrogenated rosin, and other chemically modified rosins. The modified rosin is a modified version of unmodified rosin, and examples thereof include rosin esters, unsaturated carboxylic acid-modified rosins, unsaturated carboxylic acid-modified rosin esters, amide compounds of rosin, and amine salts of rosin.

The styrene-based resin is a polymer using a styrene monomer as a constituent monomer, and examples thereof include a polymer obtained by polymerizing a styrene monomer as a main component (50 mass % or more). Specifically, it includes homopolymers obtained by individually polymerizing styrene monomers (styrene, o-methylstyrene, m-methylstyrene, p-methylstyrene, α-methylstyrene, p-methoxystyrene, p-tert-butylstyrene, p-phenylstyrene, o-chlorostyrene, m-chlorostyrene, p-chlorostyrene, etc.), copolymers obtained by copolymerizing two or more of the styrene monomers, and, in addition, copolymers obtained by copolymerizing a styrene monomer and other monomers that can be copolymerized with the styrene monomer. Among these examples, a styrene-based resin prepared using α-methylstyrene as a styrene-based monomer is preferred.

Examples of the other monomers include acrylonitriles such as acrylonitrile and methacrylate; unsaturated carboxylic acids such as acrylic acid and methacrylic acid; unsaturated carboxylic acid esters such as methyl acrylate and methyl methacrylate; dienes such as chloroprene, butadiene, and isoprene, olefins such as 1-butene and 1-pentene, α,ß-unsaturated carboxylic acids such as maleic anhydride, and acid anhydrides thereof.

Among coumaron-based resins, coumaron indene resin is preferred. Coumaron indene resin is a resin containing coumaron and indene as monomer components that constitute the skeleton (main chain) of the resin. In addition to coumaron and indene, a monomer component such as styrene, α-methylstyrene, methylindene, and vinyltoluene may be contained in the skeleton.

The hydroxyl value (OH value) of the coumarone-indene resin is, for example, more than 15 mg KOH/g and less than 150 mg KOH/g. The OH value is the amount of potassium hydroxide required to neutralize acetic acid bonded to a hydroxyl group when 1 g of the resin is acetylated, and is expressed in milligrams. It is a value measured by potentiometric titration method (JIS K 0070:1992).

The softening point of the coumarone-indene resin is, for example, higher than 30° C. and less than 160° C. The softening point is the temperature at which the ball drops when the softening point defined in JIS K 6220-1:2001 is measured by a ring-ball type softening point measuring device.

Examples of the terpene resins include polyterpenes, terpene phenols, and aromatic-modified terpene resins. Polyterpene is a resin obtained by polymerizing a terpene compound and a hydrogenated product thereof. The terpene compound is a hydrocarbon having a composition of (C₅H₈) n or an oxygen-containing derivative thereof, which is a compound having a terpene classified as monoterpenes (C₁₀H₁₆), sesquiterpenes (C₁₅H₂₄), diterpenes (C₂₀H₃₂), etc. as the basic skeleton. Examples thereof include α-pinene, ß-pinene, dipentene, limonene, myrcene, alloocimene, osimene, α-phellandrene, α-terpinene, γ-terpinene, terpinolene, 1,8-cineol, 1,4-cineol, α-terpineol, ß-terpineol, and γ-terpineol.

Examples of the polyterpene include terpene resins such as α-pinene resin, ß-pinene resin, limonene resin, dipentene resin, and ß-pinene/limonene resin, which are made from the above-mentioned terpene compound, as well as a hydrogenated terpene resin obtained by hydrogenating the terpene resin. Examples of the terpene phenol include a resin obtained by copolymerizing the above-mentioned terpene compound and the phenolic compound, and a resin obtained by hydrogenating above-mentioned resin. Specifically, a resin obtained by condensing the above-mentioned terpene compound, the phenol compound and the formalin can be mentioned. Examples of the phenolic compound include phenol, bisphenol A, cresol, and xylenol. Examples of the aromatic-modified terpene resin include a resin obtained by modifying a terpene resin with an aromatic compound, and a resin obtained by hydrogenating above-mentioned resin. The aromatic compound is not particularly limited as long as it is a compound having an aromatic ring, and examples thereof include phenol compounds such as phenol, alkylphenol, alkoxyphenol, and unsaturated hydrocarbon group-containing phenol; naphthol compounds such as naphthol, alkylnaphthol, alkoxynaphthol, and unsaturated hydrocarbon group-containing naphthols; styrene derivatives such as styrene, alkylstyrene, alkoxystyrene, unsaturated hydrocarbon group-containing styrene; coumaron, and indene.

The “C5 resin” refers to a resin obtained by polymerizing a C5 fraction. Examples of the C5 fraction include petroleum fractions having 4 to 5 carbon atoms such as cyclopentadiene, pentene, pentadiene, and isoprene. As the C5-based petroleum resin, a dicyclopentadiene resin (DCPD resin) is preferably used.

The “C9 resin” refers to a resin obtained by polymerizing a C9 fraction, and may be hydrogenated or modified. Examples of the C9 fraction include petroleum fractions having 8 to 10 carbon atoms such as vinyltoluene, alkylstyrene, indene, and methyl indene. As specific examples, a coumarone-indene resin, a coumarone resin, an indene resin, and an aromatic vinyl resin are preferably used. As the aromatic vinyl resin, a homopolymer of α-methylstyrene or styrene or a copolymer of α-methylstyrene and styrene is preferable because it is economical, easy to process, and excellent in heat generation properties. A copolymer of α-methylstyrene and styrene is preferred. As the aromatic vinyl-based resin, for example, those commercially available from Kraton Corporation, Eastman Chemical Company, etc. can be used.

The “C5C9 resin” refers to a resin obtained by copolymerizing the C5 fraction and the C9 fraction, and may be hydrogenated or modified. Examples of the C5 fraction and the C9 fraction include the above-mentioned petroleum fraction. As the C5C9 resin, for example, those commercially available from Tosoh Corporation, LUHUA Corporation, etc. can be used.

Although the acrylic resin is not particularly limited, for example, a solvent-free acrylic resin can be used.

As the solvent-free acrylic resin, a (meth)acrylic resin (polymer) synthesized by a high temperature continuous polymerization method (high-temperature continuous lump polymerization method: a method described in U.S. Pat. No. 4,414,370 B, JP 84-6207 A, JP 93-58805 A, JP 89-313522 A, U.S. Pat. No. 5,010,166 B, Toa Synthetic Research Annual Report TREND2000 No. 3, p 42-45, etc.) without using polymerization initiators, chain transfer agents, organic solvents, etc. as auxiliary raw materials as much as possible, can be mentioned. In the present invention, (meth)acrylic means methacrylic and acrylic.

Examples of monomer components constituting the acrylic resin include (meth)acrylic acid, (meth)acrylic acid esters (alkyl esters, aryl esters, aralkyl esters, etc.), (meth)acrylamide, and (meth)acrylic acid derivatives such as (meth)acrylamide derivatives.

As the monomer component constituting the acrylic resin, aromatic vinyl compounds such as styrene, α-methylstyrene, vinyltoluene, vinylnaphthalene, divinylbenzene, trivinylbenzene, divinylnaphthalene, and the like may be used, together with (meth)acrylic acid or (meth)acrylic acid derivative.

The acrylic resin may be a resin composed of only a (meth)acrylic component or a resin also having a component other than the (meth)acrylic component. The acrylic resin may have a hydroxyl group, a carboxyl group, a silanol group, or the like.

Examples of the resin component which can be used include products of Maruzen Petrochemical Co., Ltd., Sumitomo Bakelite Co., Ltd., Yasuhara Chemical Co., Ltd., Tosoh Corporation, Rutgers Chemicals Co., Ltd., BASF Co., Ltd., Arizona Chemical Co., Ltd., Nitto Chemical Co., Ltd., Nippon Shokubai Co., Ltd., ENEOS Co., Ltd., Arakawa Chemical Industry Co., Ltd., and Taoka Chemical Industry Co., Ltd.

(b-3) Stearic Acid

The rubber composition preferably contains stearic acid. The content of stearic acid is, for example, preferably more than 0.5 part by mass, more preferably 1.0 part by mass or more, and even more preferably 2.0 parts by mass or more, per 100 parts by mass of the total rubber component. On the other hand, the upper limit is, for example, preferably less than 10.0 parts by mass, more preferably 5.0 parts by mass or less. As the stearic acid, conventionally known products can be used, such as products from NOF Corporation, Kao Corporation, FUJIFILM Wako Pure Chemical Corporation, Chiba Fatty Acid Co., Ltd., etc.

(b-4) Antiaging Agents

In the present invention, the rubber composition preferably contains an antiaging agent. The content of the antiaging agent is, for example, preferably more than 0.5 part by mass, more preferably 1 part by mass or more, and even more preferably 2 parts by mass or more, and is preferably less than 10 parts by mass, more preferably 8 parts by mass or less, more preferably 6 parts by mass or less, and even more preferably 4.5 parts by mass or less, per 100 parts by mass of the total rubber component.

Examples of the antiaging agent include a naphthylamine-based antiaging agent such as phenyl-α-naphthylamine; a diphenylamine-based antiaging agent such as octylated diphenylamine or 4,4′-bis(α,α′-dimethylbenzyl)diphenylamine; a p-phenylenediamine-based antiaging agent such as N-isopropyl-N′-phenyl-p-phenylenediamine, N-(1,3-dimethylbutyl)-N′-phenyl-p phenylenediamine or N,N′-di-2-naphthyl-p-phenylenediamine; a quinoline-based antiaging agent such as polymers of 2,2,4-trimethyl-1,2-dihydroquinoline; a monophenol-based antiaging agent such as 2,6-di-t-butyl-4-methylphenol or styrenated phenol; a bis-, tris-, and polyphenol-based antiaging agent such as tetrakis-[methylene-3-(3′,5′-di-t-butyl-4′-hydroxyphenyl) propionate]methane. These antiaging agents may be used alone or in combination of two or more.

As the antiaging agent, for example, products available from Seiko Chemical Co., Ltd., SUMITOMO CHEMICAL COMPANY, LIMITED, OUCHI SHINKO CHEMICAL INDUSTRIAL CO., LTD., Flexis, Inc., Eastman Chemical Company, etc. can be used.

(b-5) Wax

In the present invention, the rubber composition preferably contains a wax. The content of the wax is, for example, preferably 0.5 part by mass or more, more preferably 1.0 part by mass or more, even more preferably 1.5 parts by mass or more, and even more preferably 2.5 parts by mass or more, per 100 parts by mass of the total rubber component. On the other hand, the upper limit is, for example, preferably 20 parts by mass or less, more preferably 15 parts by mass or less, and even more preferably 10 parts by mass or less.

The wax is not particularly limited, and examples thereof include a petroleum wax such as a paraffin wax or a microcrystalline wax; a natural wax such as a vegetable wax and an animal wax; and a synthetic wax such as a polymer of ethylene, or propylene, etc. Such waxes may be used alone or in combination of two or more.

As the wax, for example, a product from OUCHI SHINKO CHEMICAL INDUSTRIAL CO., LTD., Nippon Seiro Co., Ltd., Seiko Chemical Co., Ltd., etc. can be used.

(b-6) Zinc Oxide

The rubber composition may contain zinc oxide. The content of the zinc oxide is, for example, preferably more than 0.5 part by mass, more preferably 2 parts by mass or more, while it is preferably less than 10 parts by mass, more preferably 5 parts by mass or less, per 100 parts by mass of the total rubber component. As the zinc oxide, a conventionally known product can be used, and, for example, a product from MITSUI KINZOKU COMPANY, LIMITED, Toho Zinc Co., Ltd., HAKUSUI TECH CO., LTD., Seido Chemical Industry Co., Ltd., SAKAI CHEMICAL INDUSTRY CO., LTD., etc. can be used.

(b-7) Crosslinking Agent and Vulcanization Accelerator

The rubber composition preferably contains a crosslinking agent such as sulfur. The content of the crosslinking agent is, for example, preferably more than 0.1 part by mass and more preferably 1.2 parts by mass or more, while it is preferably less than 10.0 parts by mass, more preferably 5 parts by mass or less, per 100 parts by mass of the total rubber component.

Examples of the sulfur include a powdered sulfur, a precipitated sulfur, a colloidal sulfur, an insoluble sulfur, a highly dispersible sulfur, a soluble sulfur, etc., which are commonly used in the rubber industry. These may be used alone or in combination of two or more.

As the sulfur, for example, products from Tsurumi Chemical Industry Co., Ltd., Karuizawa Iso Co., Ltd., SHIKOKU CHEMICALS CORPORATION, Flexis Corporation, NIPPON KANRYU INDUSTRY CO., LTD, Hosoi Chemical Industry Co., Ltd, etc. can be used.

Examples of the crosslinking agent other than sulfur include a vulcanizing agent containing a sulfur atom, such as Tackirol V200 manufactured by Taoka Chemical Co., Ltd., or KA9188 (1,6-bis (N,N′-dibenzylthiocarbamoyldithio) hexane) manufactured by Lanxess, and an organic peroxide such as di-cumyl peroxide.

The rubber composition preferably contains a vulcanization accelerator. The content of the vulcanization accelerator is, for example, preferably more than 0.3 part by mass and more preferably 4.5 parts by mass or more, while it is preferably less than 10.0 parts by mass, and more preferably 6 parts by mass or less, per 100 parts by mass of the total rubber component.

Examples of the vulcanization accelerator include thiazole-based vulcanization accelerators such as 2-mercaptobenzothiazole, di-2-benzothiazolyl disulfide, and N-cyclohexyl-2-benzothiadylsulfenamide; thiuram-based vulcanization accelerators such as tetramethylthiuram disulfide (TMTD), tetrabenzyltiuram disulfide (TBzTD), and tetrakis (2-ethylhexyl) thiuram disulfide (TOT-N); sulfenamide-based vulcanization accelerators such as N-cyclohexyl-2-benzothiazolesulfenamide, N-t-butyl-2-benzothiazolyl sulfenamide, N-oxyethylene-2-benzothiazolesulfenamide, and N,N′-diisopropyl-2-benzothiazolesulfenamide; and guanidine-based vulcanization accelerators such as diphenylguanidine, di-ortho-tolylguanidine and ortho-tolylbiguanidine. These may be used alone or in combination of two or more.

(b-8) Others

In addition to the above components, the rubber composition may further contain, as necessary, an additive commonly used in the tire industry, such as a fatty acid metal salt, a carboxylic acid metal salt, an organic peroxide, a reversion inhibitor, etc. The content of such an additive is, for example, more than 0.1 part by mass and less than 200 parts by mass per 100 parts by mass of the total rubber component.

### (2) Preparation of Rubber Composition

The rubber composition forming the tread portion is produced by appropriately adjusting the various compounding materials described above and by a general method, for example, a production method including a base kneading step in which the rubber component is kneaded with a filler such as silica or carbon black, and a finish kneading step in which a kneaded product obtained in the base kneading step is kneaded with a crosslinking agent.

The kneading can be carried out using a known (sealed) kneading machine such as a Banbury mixer, a kneader, or an open roll.

The kneading temperature in the base kneading step is, for example, higher than 50° C. and less than 200° C., and the kneading time is, for example, longer than 30 seconds and shorter than 30 minutes. In the base kneading step, in addition to the above-mentioned components, compounding agents conventionally used in the rubber industry, for example, softeners such as oil, zinc oxide, anti-aging agents, waxes, vulcanization accelerators, etc. may be appropriately added and kneaded as necessary.

In the finish kneading step, a kneaded product obtained in the base kneading step is kneaded with a crosslinking agent. The kneading temperature in the finish kneading step is, for example, higher than room temperature and less than 80° C., and the kneading time is, for example, longer than 1 minute and shorter than 15 minutes. In the finish kneading step, in addition to the above components, a vulcanization accelerator, zinc oxide, etc. may be appropriately added and kneaded as necessary.

### 3. Manufacturing the Tire

For the tire according to the present invention, an unvulcanized tire can be produced by molding the rubber composition obtained above into a tread rubber having a predetermined shape for the cap rubber layer, and then molding the tread rubber together with other tire components with a tire molding machine by a normal method.

When the tread portion has a multi-layer structure of the cap rubber layer and a base rubber layer, the rubber composition for forming the base rubber layer can be obtained by using the above-mentioned rubber components and compounding materials, appropriately changing compounding amounts thereof, and kneading them in the same manner as kneading for the cap rubber layer. The base rubber layer is then extruded together with the cap rubber layer to be formed into the tread rubber of a predetermined shape, and then molded together with other tire components in a tire molding machine using a normal method to produce an unvulcanized tire.

Specifically, an inner liner as a member for ensuring airtightness of the tire, a carcass as a member that withstands load, impact, and filled air pressure received by the tire, and a belt as a member that tightly fastens the carcass and increases rigidity of the tread are wound around a molding drum, and both ends of the carcass are fixed to both side edges, and bead portions as members for fixing the tire to a rim are arranged. After molding into a toroidal shape, a tread portion is pasted to the center of an outer periphery, and sidewall are pasted to an axially outside to form side portions, thereby producing an unvulcanized tire.

The unvulcanized tire thus produced is then heated and pressurized in a vulcanizer to obtain a tire. A vulcanization step can be carried out by applying a known vulcanization method. A vulcanization temperature is, for example, higher than 120° C. and less than 200° C., and a vulcanization time is, for example, longer than 5 minutes and shorter than 15 minutes.

It is believed that the obtained tire can achieve a further improvement in wet grip performance of the tire by exerting the above-described effects in cooperation with each other.

The tire according to the present invention is not particularly limited to a particular category, and can be used as a passenger car tire, a large passenger car tire, a large SUV tire, a truck/bus tire, a motorcycle tire, a racing tire, a stud less tire (winter tire), an all-season tire, a run-flat tire, an aircraft tire, a mining tire, a non-pneumatic tire, or the like, but is preferably used as a passenger car tire.

### EXAMPLE

Examples, i.e., embodiments that are considered preferable for carrying out the present invention, are described below, but the scope of the present invention is not limited to the examples.

The tires made of a tread molded from various compounding materials shown below and other rubber components are examined, and the results calculated based on the evaluation method for the wet grip performance described below are also shown at the bottom of Tables 2 to 5.
1. Rubber composition for forming the tread portions (cap rubber composition)
(1) Compounding materials
(a) Rubber component
(i) NR: TSR20
(ii) SBR-1: TUFDENE 2000R (modified S-SBR) manufactured by Asahi Kasei Corporation
(styrene content: 25 mass %, vinyl content: 10 mass %, Tg=−65° C., non-oil extended)
(iii) SBR-2: F1810 (modified S-SBR) manufactured by LG Chem. Ltd.
(styrene content: 18 mass %, vinyl content: 10 mass %, Tg=−73° C., 5% oil extended)
(iv) SBR-3: HPR850 (modified S-SBR) manufactured by ENEOS Materials Corporation
(styrene content: 27.5 mass %, vinyl content: 59 mass %, Tg: −24° C., non-oil extended)
(v) BR: Ubepol BR150B (High-cis BR) manufactured by UBE Corporation
(cis content: 97 mass %, trans content: 2 mass %, vinyl content: 1 mass %)
(b) Compounding materials other than rubber components
(i) Carbon black: DIABLACK N220 manufactured by Mitsubishi Chemical Corporation (N₂SA: 115 m²/g)
(ii) Silica-1: Ultrasil 9100GR manufactured by Evonik Industries AG
(CTAB: 200 m²/g, N₂SA: 228 m²/g, BET: 235 m²/g)
(iii) Silica-2: Zeosil Premium SW manufactured by Solvay
(CTAB: 245 m²/g, N₂SA: 275 m²/g, BET: 258 m²/g)
(iv) Silane coupling agent-1: Si266 manufactured by Evonik Industries
(Bis(3-triethoxysilylpropyl) disulfide)
(v) Silane coupling agent-2: NXT manufactured by Momentive Performance Materials Worldwide LLC
(3-octanoylthiopropyltriethoxysilane)
(vi) Resin component-1: SYLVATRAXX 4401 manufactured by Kraton Corporation
(α-methylstyrene resin)
(vii) Resin component-2: SYLVATRAXX 8022 manufactured by Kraton Corporation
(Polyterpene resin)
(viii) Resin component-3: Opera PR 383 manufactured by Exxon Mobil Corporation
(Hydrogenated DCPD-C9 resin, aromaticity degree: 9.6 mass %, softening point: 103° C., Mw: 770)
(ix) Resin component-4 (liquid rubber): Ricon 340 manufactured by Cray Valley
(aliphatic liquid polymer)
(x) Oil-1: H&R Vivatec 500
(Aromatic process oil: TDAE oil)
(xi) Oil-2: High oleic acid sunflower oil manufactured by Orisoy (vegetable oil, oleic acid ratio: 82%, polyunsaturated fatty acid ratio: 9%, saturated fatty acid ratio: 9%)
(xii) Wax: OZOACE 0355 (paraffin wax) manufactured by Nippon Seiro Co., Ltd.
(xiii) Antiaging agent-1: NOCRAC 6C manufactured by OUCHI SHINKO CHEMICAL INDUSTRIAL CO., LTD.
(N-(1,3-dimethylbutyl)-N′-phenyl-p-phenylenediamine)
(xiv) Anti-aging agent-2: NOCRAC RD manufactured by OUCHI SHINKO CHEMICAL INDUSTRIAL CO., LTD.
(Poly(2,2,4-trimethyl-1,2-dihydroquinoline))
(xv) Stearic acid: bead stearic acid “Tsubaki” manufactured by NOF Corporation
(xvi) Zinc oxide: Zinc oxide No. 1 manufactured by MITSUI KINZOKU COMPANY, LIMITED
(xvii) Sulfur: Powdered sulfur manufactured by Tsurumi Chemical Industry Co., Ltd.
(xviii) Vulcanization accelerator-1: Nocceler CZ manufactured by Ouchi Shinko Chemical Industry Co., Ltd.
(N-cyclohexyl-2-benzothiazolylsulfenamide (CBS))
(xix) Vulcanization accelerator-2: Nocceler D manufactured by OUCHI SHINKO CHEMICAL INDUSTRIAL CO., LTD.
(N,N′-diphenylguanidine (DPG))

### (2) Rubber Composition Forming the Tread Portion (Cap Rubber Layer)

According to the formulations shown in Tables 2 to 5, materials other than sulfur and a vulcanization accelerator are kneaded for 5 minutes under the condition of 150° C. using a Banbury mixer to obtain a kneaded mixture. The amounts of each compound are in parts by mass.

Next, sulfur and a vulcanization accelerator are added to the kneaded mixture, and the mixture is kneaded for 5 minutes at 80° C. using an open roll to obtain a rubber composition (cap rubber composition) for forming the tread portion.

### 2. Rubber Composition Forming the Base Rubber Layer (Base Rubber Composition)

In parallel, a rubber composition for forming the base rubber layer (base rubber composition) is obtained in the same manner as in the production of the cap rubber composition, based on the formulation shown in Table 1.

TABLE 1

| | Content |
|---|---|
| | (parts |
| Compound material | by mass) |
| NR (TSR20) | 70 |
| BR (UBEPOL-BR150B manufactured by UBE | 30 |
| Corporation) | |
| Carbon black (Showblack N330 T manufactured by | 35 |
| Cabot Japan K.K.) | |
| Stearic acid (stearic acid “Tsubaki” | 2 |
| by NOF Corporation) | |
| Zinc oxide (Zinc oxide No. 1 manufactured by MITSUI | 4 |
| KINZOKU COMPANY, LIMITED) | |
| Wax (SUNNOC Wax manufactured by OUCHI SHINKO | 2 |
| CHEMICAL INDUSTRIAL CO., LTD.) | |
| Antiaging agent (NOCRAC 6C manufactured by OUCHI | 3 |
| SHINKO CHEMICAL INDUSTRIAL CO., LTD.) | |
| Antiaging agent (ANTAGE RD manufactured by | 1 |
| KAWAGUCHI CHEMICAL INDUSTRY CO., LTD.) | |
| Sulfur (powdered sulfur manufactured by Tsurumi | 1.7 |
| Chemical Industry Co., Ltd.) | |
| Vulcanization accelerator (NOCCELER CZ-G | 1.2 |
| manufactured by OUCHI SHINKO CHEMICAL | |
| INDUSTRY CO., LTD.) | |

### 3. Manufacturing of Pneumatic Tires

Each pair of one of the cap rubber compositions and the base rubber composition is extruded into a predetermined shape to produce a tread portion.

Thereafter, the unvulcanized tire is formed by laminating these compositions together with other tire components, and the unvulcanized tire is press-vulcanized for 10 minutes under a condition of 170° C. to produce test tires of Examples 1 to 21 and Comparative Examples 1 to 3 shown in Tables 2 to 4 (tire size: 215/45R17, the land ratio La: 0.65, the depth D of the main groove: 9 mm, the maximum load capacity WL: 555 kg, the weight G: 8.8 kg, G/WL: 0.0159), and test tires of Examples 22 to 24 and Comparative Example 4 shown in Table 5 (tire size: 195/65R15, the land ratio La: 0.65, the depth D of the main groove: 8 mm, the maximum load capacity WL: 609 kg, the weight G: 8.2 kg, G/WL: 0.0135).

### 4. Calculation of Parameters

The following parameters are then determined for each test tire.

### (1) Acetone Extractable Content (AE) of the Rubber Composition Forming the Tread Portion

Using a vulcanized rubber test piece cut out from the tread portion of each test tire, the acetone extractable content AE (mass %) is determined in accordance with JIS K 6229:2015.

$$FA \times AE , La \times AE , La \times CTAB \qquad ( 2 )$$

FA×AE, La×AE, and La×CTAB are calculated based on the specifications of each test tire and compounding contents.

### 5. Performance Evaluation Test (Evaluation of the Wet Grip Performance)

Each test tire is fitted to all wheels of a vehicle (an FF vehicle made in Japan with an engine displacement of 2000 cc) and inflated to the internal pressure of 250 kPa. The vehicle is then driven on a test course with a wet asphalt surface, and the braking distance from the initial speed of 100 km/h is measured.

Next, the result of Comparative Example 3 for Tables 1 to 3, and the result of Comparative Example 41 for Table 4 are used as the “evaluation standard”, and are indexed according to the following formula to evaluate wet grip performance. A larger value indicates a shorter braking distance and better wet grip performance.

$$Wet grip performance = ( Evaluation standard ) / [ ( Test tire result ) ] \times 100$$

TABLE 2

| Example | Example | Example | Example | Example | Example | Example | Example |
|---|---|---|---|---|---|---|---|
| 1 | 2 | 3 | 4 | 5 | 6 | 7 | 8 |

Tread rubber composition

| | | | | | | | | |
|---|---|---|---|---|---|---|---|---|
| NR | 20 | 20 | 5 | 5 | 20 | 20 | 5 | 5 |
| SBR-1 | 65 | 65 | 65 | 80 | 65 | 65 | 65 | 0 |
| SBR-2 | 0 | 0 | 0 | 0 | 0 | 0 | 0 | 84 |
| (Rubber portion) | 0 | 0 | 0 | 0 | 0 | 0 | 0 | 80 |
| (oil content) | 0 | 0 | 0 | 0 | 0 | 0 | 0 | 4 |
| BR | 15 | 15 | 30 | 15 | 15 | 15 | 30 | 15 |
| Carbon Black | 10 | 10 | 10 | 10 | 10 | 10 | 10 | 10 |
| Silica-1 | 130 | 140 | 130 | 140 | 0 | 0 | 0 | 0 |
| Silica-2 | 0 | 0 | 0 | 0 | 100 | 130 | 100 | 130 |
| Silane coupling agent-1 | 13 | 14 | 13 | 14 | 10 | 13 | 10 | 13 |
| Silane coupling agent-2 | 0 | 0 | 0 | 0 | 0 | 0 | 0 | 0 |
| Resin component-1 | 20 | 30 | 20 | 30 | 20 | 30 | 20 | 30 |
| Resin component-2 | 0 | 0 | 0 | 0 | 0 | 0 | 0 | 0 |
| Oil-1 | 50 | 50 | 50 | 50 | 25 | 42 | 26 | 45 |
| Wax | 2.5 | 2.5 | 2.5 | 2.5 | 2.5 | 2.5 | 2.5 | 2.5 |
| Anti-aging agent-1 | 3 | 3 | 3 | 3 | 3 | 3 | 3 | 3 |
| Anti-aging agent-2 | 1.5 | 1.5 | 1.5 | 1.5 | 1.5 | 1.5 | 1.5 | 1.5 |
| stearic acid | 2 | 2 | 2 | 2 | 2 | 2 | 2 | 2 |
| zinc oxide | 2 | 2 | 2 | 2 | 2 | 2 | 2 | 2 |
| sulfur | 1.2 | 1.2 | 1.2 | 1.2 | 1.2 | 1.2 | 1.2 | 1.2 |
| Vulcanization accelerator-1 | 2.5 | 2.5 | 2.5 | 2.5 | 2.5 | 2.5 | 2.5 | 2.5 |
| Vulcanization accelerator-2 | 2 | 2 | 2 | 2 | 2 | 2 | 2 | 2 |

Parameter

| | | | | | | | | |
|---|---|---|---|---|---|---|---|---|
| styrene content | 16.25 | 16.25 | 16.25 | 20.00 | 16.25 | 16.25 | 16.25 | 14.40 |
| [symbol] | | | | | | | | |
| vinyl content | 6.10 | 6.10 | 5.13 | 6.32 | 6.10 | 6.10 | 5.13 | 6.91 |
| [symbol] | | | | | | | | |
| Total filler content FA | 140 | 150 | 140 | 150 | 110 | 140 | 110 | 140 |
| CTAB | 200 | 200 | 200 | 200 | 245 | 245 | 245 | 245 |
| AE (mass %) | 24.50 | 25.84 | 24.43 | 25.74 | 20.66 | 24.94 | 20.86 | 28.17 |
| FA × AE | 3430 | 3876 | 3420 | 3861 | 2273 | 3492 | 2295 | 3944 |
| La × AE | 16 | 17 | 16 | 17 | 13 | 16 | 14 | 18 |
| La × CTAB | 130 | 130 | 130 | 130 | 159 | 159 | 159 | 159 |

Performance evaluation

| | | | | | | | | |
|---|---|---|---|---|---|---|---|---|
| Wet grip performance | 111 | 114 | 112 | 113 | 106 | 118 | 107 | 126 |

[symbol]

indicates data missing or illegible when filed

TABLE 3

| Example | Example | Example | Example | Example | Example | Example | Example |
|---|---|---|---|---|---|---|---|
| 9 | 10 | 11 | 12 | 13 | 14 | 15 | 16 |

Tread rubber composition

| | | | | | | | | |
|---|---|---|---|---|---|---|---|---|
| NR | 20 | 20 | 20 | 20 | 20 | 5 | 5 | 5 |
| SBR-2 | 68.25 | 68.25 | 68.25 | 68.25 | 68.25 | 84 | 84 | 84 |
| (Rubber portion) | 65 | 65 | 65 | 65 | 65 | 80 | 80 | 80 |
| (oil content) | 3.25 | 3.25 | 3.25 | 3.25 | 3.25 | 4 | 4 | 4 |
| BR | 15 | 15 | 15 | 15 | 15 | 15 | 15 | 15 |
| Carbon Black | 10 | 10 | 10 | 10 | 10 | 10 | 10 | 10 |
| Silica-1 | 0 | 0 | 0 | 160 | 180 | 0 | 0 | 0 |
| Silica-2 | 150 | 160 | 180 | 0 | 0 | 150 | 160 | 180 |
| Silane coupling agent-1 | 15 | 16 | 18 | 16 | 18 | 15 | 16 | 18 |
| Resin component-1 | 50 | 40 | 40 | 40 | 40 | 0 | 20 | 40 |
| Resin component-2 | 0 | 20 | 40 | 20 | 40 | 10 | 0 | 0 |
| Resin component-3 | 0 | 0 | 0 | 0 | 0 | 40 | 40 | 40 |
| Oil-1 | 40 | 34 | 26 | 32 | 23 | 40 | 32 | 25 |
| Wax | 2.5 | 2.5 | 2.5 | 2.5 | 2.5 | 2.5 | 2.5 | 2.5 |
| Anti-aging agent-1 | 3 | 3 | 3 | 3 | 3 | 3 | 3 | 3 |
| Anti-aging agent-2 | 1.5 | 1.5 | 1.5 | 1.5 | 1.5 | 1.5 | 1.5 | 1.5 |
| stearic acid | 2 | 2 | 2 | 2 | 2 | 2 | 2 | 2 |
| zinc oxide | 2 | 2 | 2 | 2 | 2 | 2 | 2 | 2 |
| sulfur | 1.2 | 1.2 | 1.2 | 1.2 | 1.2 | 1.2 | 1.2 | 1.2 |
| Vulcanization accelerator-1 | 2.5 | 2.5 | 2.5 | 2.5 | 2.5 | 2.5 | 2.5 | 2.5 |
| Vulcanization accelerator-2 | 2 | 2 | 2 | 2 | 2 | 2 | 2 | 2 |

Parameter

| | | | | | | | | |
|---|---|---|---|---|---|---|---|---|
| styrene content | 11.70 | 11.70 | 11.70 | 11.70 | 11.70 | 14.40 | 14.40 | 14.40 |
| [symbol] | | | | | | | | |
| vinyl content | 8.20 | 8.20 | 8.20 | 8.20 | 8.20 | 8.20 | 8.20 | 8.20 |
| [symbol] | | | | | | | | |
| Total filler content FA | 160 | 170 | 190 | 170 | 190 | 160 | 170 | 190 |
| CTAB | 245 | 245 | 245 | 200 | 200 | 245 | 245 | 245 |
| AE (mass %) | 29.01 | 28.92 | 29.42 | 28.56 | 28.93 | 29.13 | 28.90 | 29.57 |
| FA × AE | 4642 | 4916 | 5590 | 4855 | 5497 | 4661 | 4913 | 5618 |
| La × AE | 19 | 19 | 19 | 19 | 19 | 19 | 19 | 19 |
| La × CTAB | 159 | 159 | 159 | 130 | 130 | 159 | 159 | 159 |

Performance evaluation

| | | | | | | | | |
|---|---|---|---|---|---|---|---|---|
| Wet grip performance | 141 | 141 | 149 | 137 | 144 | 136 | 138 | 145 |

[symbol]

indicates data missing or illegible when filed

TABLE 4

| Example | Example | Example | Example | Example | Comparative Example | | |
|---|---|---|---|---|---|---|---|
| 17 | 18 | 19 | 20 | 21 | 1 | 2 | 3 |

Tread rubber composition

| | | | | | | | | |
|---|---|---|---|---|---|---|---|---|
| NR | 5 | 5 | 0 | 0 | 0 | 20 | 20 | 50 |
| SBR-1 | 0 | 0 | 0 | 0 | 0 | 65 | 65 | 0 |
| SBR-2 | 84 | 84 | 63 | 63 | 64.05 | 0 | 0 | 0 |
| (Rubber portion) | 80 | 80 | 60 | 60 | 61 | 0 | 0 | 0 |
| (oil content) | 4 | 4 | 3 | 3 | 3.05 | 0 | 0 | 0 |
| SBR-3 | 0 | 0 | 0 | 0 | 0 | 0 | 0 | 35 |
| BR | 15 | 15 | 40 | 40 | 40 | 15 | 15 | 15 |
| Carbon Black | 10 | 10 | 10 | 10 | 10 | 10 | 55 | 10 |
| Silica-1 | 160 | 180 | 0 | 0 | 0 | 65 | 65 | 130 |
| Silica-2 | 0 | 0 | 150 | 160 | 180 | 0 | 0 | 0 |
| Silane coupling agent-1 | 16 | 18 | 15 | 16 | 18 | 6 | 6 | 6 |
| Resin component-1 | 40 | 40 | 0 | 20 | 40 | 20 | 20 | 20 |
| Resin component-2 | 0 | 0 | 10 | 0 | 0 | 0 | 0 | 0 |
| Resin component-3 | 20 | 40 | 40 | 40 | 40 | 0 | 0 | 0 |
| Resin component-4 | 0 | 0 | 0 | 0 | 15 | 0 | 0 | 0 |
| Oil-1 | 35 | 22 | 15 | 36 | 13 | 10 | 20 | 50 |
| Wax | 2.5 | 2.5 | 2.5 | 2.5 | 2.5 | 2.5 | 2.5 | 2.5 |
| Anti-aging agent-1 | 3 | 3 | 3 | 3 | 3 | 3 | 3 | 3 |
| Anti-aging agent-2 | 1.5 | 1.5 | 1.5 | 1.5 | 1.5 | 1.5 | 1.5 | 1.5 |
| stearic acid | 2 | 2 | 2 | 2 | 2 | 2 | 2 | 2 |
| zinc oxide | 2 | 2 | 2 | 2 | 2 | 2 | 2 | 2 |
| sulfur | 1.2 | 1.2 | 1.2 | 1.2 | 1.2 | 1.2 | 1.2 | 1.2 |
| Vulcanization accelerator-1 | 2.5 | 2.5 | 2.5 | 2.5 | 2.5 | 2.5 | 2.5 | 2.5 |
| Vulcanization accelerator-2 | 2 | 2 | 2 | 2 | 2 | 2 | 2 | 2 |

Parameter

| | | | | | | | | |
|---|---|---|---|---|---|---|---|---|
| styrene content | 14.40 | 14.40 | 10.80 | 10.80 | 10.98 | 16.25 | 16.25 | 9.63 |
| [symbol] | | | | | | | | |
| vinyl content | 8.20 | 8.20 | 8.20 | 8.20 | 8.20 | 8.20 | 8.20 | 8.20 |
| [symbol] | | | | | | | | |
| Total filler content FA | 170 | 190 | 160 | 170 | 190 | 75 | 120 | 140 |
| CTAB | 200 | 200 | 245 | 245 | 245 | 200 | 200 | 200 |
| AE (mass %) | 29.43 | 29.08 | 29.70 | 29.07 | 29.55 | 18.41 | 18.37 | 24.82 |
| FA × AE | 5003 | 5525 | 4752 | 4942 | 5615 | 1381 | 2204 | 3475 |
| La × AE | 19 | 19 | 19 | 19 | 19 | 12 | 12 | 16 |
| La × CTAB | 130 | 130 | 159 | 159 | 159 | 130 | 130 | 130 |

Performance evaluation

| | | | | | | | | |
|---|---|---|---|---|---|---|---|---|
| Wet grip performance | 136 | 140 | 148 | 137 | 146 | 100 | 105 | 110 |

[symbol]

indicates data missing or illegible when filed

TABLE 5

| | | | |
|---|---|---|---|
| Example | Example | Example | Comparative |
| [symbol] | [symbol] | [symbol] | [symbol] |

Tread rubber composition

| | | | | |
|---|---|---|---|---|
| NR | 30 | 20 | 5 | 30 |
| SBR-2 | 57.75 | 68.25 | 68.25 | 57.75 |
| (Rubber portion) | 55 | 65 | 65 | 55 |
| (oil content) | 2.75 | 3.25 | 3.25 | 2.75 |
| BR | 15 | 15 | 30 | 15 |
| Carbon Black | 10 | 10 | 10 | 10 |
| Silica-1 | 130 | 180 | 50 | 65 |
| Silica-2 | 0 | 0 | 135 | 0 |
| Silane coupling | 13 | 18 | 18 | 6.5 |
| agent-2 | | | | |
| Resin component-2 | 50 | 40 | 40 | 50 |
| Resin component-3 | 0 | 20 | 40 | 0 |
| Resin component-4 | 10 | 0 | 10 | 10 |
| Oil-2 | 5 | 13 | 0 | 0 |
| Wax | 2.5 | 2.5 | 2.5 | 2.5 |
| Anti-aging agent-1 | 3 | 3 | 3 | 3 |
| Anti-aging agent-2 | 1.5 | 1.5 | 1.5 | 1.5 |
| stearic acid | 2 | 2 | 2 | 2 |
| zinc oxide | 2 | 2 | 2 | 2 |
| sulfur | 1.2 | 1.2 | 1.2 | 1.2 |
| Vulcanization | 2.5 | 2.5 | 2.5 | 2.5 |
| accelerator-1 | | | | |
| Vulcanization | 2 | 2 | 2 | 2 |
| accelerator-2 | | | | |

Parameter

| | | | | |
|---|---|---|---|---|
| styrene content | 9.90 | 11.70 | 11.70 | 9.90 |
| [symbol] | | | | |
| vinyl content | 6.45 | 6.66 | 5.61 | 6.45 |
| [symbol] | | | | |
| Total filler | 140 | 190 | 195 | 75 |
| amount FA | | | | |
| CTAB | 200 | 200 | 233 | 201 |
| AE (mass %) | 26.71 | 25.27 | 27.93 | 32.14 |
| FA × AE | 3739 | 4801 | 5446 | 2411 |
| La × AE | 17 | 16 | 18 | 21 |
| La × CTAB | 130 | 130 | 151 | 131 |

Performance evaluation

| | | | | |
|---|---|---|---|---|
| Wet grip performance | 118 | 124 | 144 | 100 |

[symbol]

indicates data missing or illegible when filed

Although the present invention is described above based on the embodiments, the present invention is not limited to the above-described embodiments. Various modifications may be made to the above-described embodiments within the scope of the same or equivalent to the present invention.

The present invention (1) is a pneumatic tire having a tread portion in which a main groove is formed in the tire circumferential direction, wherein
the tread portion is formed of a rubber composition which contains,
as a rubber component, styrene butadiene rubber (SBR) having a glass transition temperature of −60° C. or less, and less than 40 parts by mass of an isoprene-based rubber per 100 parts by mass of a total rubber component, and
contains, at least as a filler, 100 parts by mass or more of silica having a CTAB (Cetyl Tri-methyl Ammonium Bromide) specific surface area of 190 m²/g or more, per 100 parts by mass of the total rubber component, and
the depth D (mm) of the main groove and a total content FA (parts by mass) of the filler per 100 parts by mass of the total rubber component satisfy the following formula (1):

$$D \times FA > 800. \qquad ( 1 )$$

The present invention (2) is the pneumatic tire according to the present invention (1), wherein the rubber composition contains 30 parts by mass or more of a resin component per 100 parts by mass of the total rubber component.

The present invention (3) is the pneumatic tire according to the present invention (1) or (2), wherein styrene content in the rubber component is 25% by mass or less.

The present invention (4) is the pneumatic tire which is characterized in that vinyl content in the rubber component is 15 mass % or less, and is an optional combination with any one of the present inventions (1) to (3).

The present invention (5) is the pneumatic tire which is characterized in that the rubber composition contains 50 parts by mass or more of the SBR per 100 parts by mass of the total rubber component, and is an optional combination with any one of the present inventions (1) to (4).

The present invention (6) is the pneumatic tire which is characterized in that the rubber composition has an acetone extractable content of 23 mass % or more, and is any combination with any of the present inventions (1) to (5).

The present invention (7) is the pneumatic tire which is characterized in that the rubber composition contains, as a resin component, any one of an aromatic resin, a dicyclopentadiene resin, and a terpene resin, and is an optional combination with any of the present inventions (1) to (6).

The present invention (8) is the pneumatic tire which is characterized in that the rubber composition contains a mercapto-based silane coupling agent, and is an optional combination with any of the present inventions (1) to (7).

The present invention (9) is the pneumatic tire which is characterized in that the rubber composition contains a liquid rubber, and is any combination with any of the present inventions (1) to (8).

The present invention (10) is the pneumatic tire which is characterized in that the rubber composition contains a vegetable oil, and is any combination with any of the present inventions (1) to (9).

The present invention (11) is the pneumatic tire which is characterized in that a product of FA (parts by mass) which indicates a total content of the filler per 100 parts by mass of the total rubber component and AE (mass %) which indicates an acetone extractable content of the rubber composition satisfies the following formula (2), and is an arbitrary combination with any of the present inventions (1) to (10):

$$FA \times AE > 2 0. \qquad ( 2 )$$

The present invention (12) is the pneumatic tire which is characterized in that a product of a land ratio La of the tread portion and the AE (mass %) satisfies the following formula (3), and is an arbitrary combination with any of the present inventions (1) to (11):

$$L a \times A E > 12.5 . \qquad ( 3 )$$

The present invention (13) is the pneumatic tire which is characterized in that a product of a land ratio La of the tread portion and a CTAB specific surface area CTAB (m²/g) of the silica satisfies the following formula (4), and is an arbitrary combination with any of the present inventions (1) to (12):

$$La \times CTAB > 125. \qquad ( 4 )$$

The present invention (14) is the pneumatic tire which is characterized in that the pneumatic tire has a ratio (G/WL) of a weight G (kg) to a maximum load capacity WL (kg) of 0.0170 or less, and is an optional combination with any of the present inventions (1) to (13).

### EXPLANATION OF SYMBOLS

2 Tire
4 Tread portion
6 Sidewall
8 Wing
10 Clinch
12 Bead
14 Carcass
16 Belt
18 Band
20 Inner liner
22 Chafer
24 Tread surface
26 Main groove
28 Base rubber layer
30 Cap rubber layer
36 Carcass ply
CL Tire equatorial plane
D Depth of the main groove

What is claimed is:

1. A pneumatic tire having a tread portion in which a main groove is formed in the tire circumferential direction, wherein
the tread portion is formed of a rubber composition which contains,
as a rubber component, styrene butadiene rubber (SBR) having a glass transition temperature of −60° C. or less, and less than 40 parts by mass of an isoprene-based rubber per 100 parts by mass of a total rubber component, and
contains, at least as a filler, 100 parts by mass or more of silica having a CTAB (Cetyl Tri-methyl Ammonium Bromide) specific surface area of 190 m²/g or more, per 100 parts by mass of the total rubber component, and
the depth D (mm) of the main groove and a total content FA (parts by mass) of the filler per 100 parts by mass of the total rubber component satisfy the following formula (1):
$$D \times FA > 800. \qquad ( 1 )$$

2. The pneumatic tire according to claim 1, wherein the rubber composition contains 30 parts by mass or more of a resin component per 100 parts by mass of the total rubber component.

3. The pneumatic tire according to claim 1, wherein styrene content in the rubber component is 25 mass % or less.

4. The pneumatic tire according to claim 1, wherein vinyl content in the rubber component is 15 mass % or less.

5. The pneumatic tire according to claim 1, wherein the rubber composition contains 50 parts by mass or more of the SBR per 100 parts by mass of the total rubber component.

6. The pneumatic tire according to claim 1, wherein the rubber composition has an acetone extractable content of 23 mass % or more.

7. The pneumatic tire according to claim 1, wherein the rubber composition contains, as a resin component, any one of an aromatic resin, a dicyclopentadiene resin, and a terpene resin.

8. The pneumatic tire according to claim 1, wherein the rubber composition contains a mercapto-based silane coupling agent.

9. The pneumatic tire according to claim 1, wherein the rubber composition contains a liquid rubber.

10. The pneumatic tire according to claim 1, wherein the rubber composition contains a vegetable oil.

11. The pneumatic tire according to claim 1, wherein a product of FA (parts by mass) which indicates a total content of the filler per 100 parts by mass of the total rubber component and AE (mass %) which indicates an acetone extractable content of the rubber composition satisfies the following formula (2):
$$FA \times AE > 2 0. \qquad ( 2 )$$

12. The pneumatic tire according to claim 1, wherein a product of a land ratio La of the tread portion and the AE (mass %) satisfies the following formula (3):
$$La \times AE > 1 \; 2.5 . \qquad ( 3 )$$

13. The pneumatic tire according to claim 1, wherein a product of a land ratio La of the tread portion and a CTAB specific surface area CTAB (m²/g) of the silica satisfies the following formula (4):
$$La \times CTAB > 125. \qquad ( 4 )$$

14. The pneumatic tire according to claim 1, wherein the pneumatic tire has a ratio (G/WL) of a weight G (kg) to a maximum load capacity WL (kg) of 0.0170 or less.
